(19) United States
(12) Patent Application Publication
(10) Pub. No.: US 2025/0300847 A1
(43) Pub. Date: Sep. 25, 2025

(54) SYSTEM AND METHOD OF PROVIDING A DISTRIBUTED SYSTEM OF COMPUTING DEVICES IN A STRUCTURED OVERLAY FRAMEWORK FOR MORE RESILIENT AND RECOVERABLE OPERATION

(71) Applicant: Fellowship IP Holdings Corp., New York, NY (US)

(72) Inventors: Egor AGAFONOV, Ogdensburg, NY (US); Jeffrey S. DIEDRICH, Lincoln, IL (US); Mark Kemna, White Plains, NY (US); Mark Sulavka, Chicago, IL (US)

(21) Appl. No.: 19/082,751

(22) Filed: Mar. 18, 2025

Related U.S. Application Data
(60) Provisional application No. 63/567,179, filed on Mar. 19, 2024.

(51) Int. Cl. H04L 9/00; H04L 67/10

(52) U.S. Cl. CPC H04L 9/50; H04L 67/10

(57) ABSTRACT

A device includes a set of networked computing devices configured in a multiple-neighborhood topology, each respective computing device of the set of computing devices being configured as part of the multiple-neighborhood topology in which each respective computing device is assigned to a group of neighborhoods and follows a topology protocol. The device is configured to receive, at a first computing device in a first neighborhood, the respective transaction to be recorded on a distributed ledger, communicate the respective transaction to each neighbor of the first computing device, continue to communicate the respective transaction from neighborhood to neighborhood according to the multiple-neighborhood topology until all computing devices of the set of networked computing devices have received the respective transaction. Upon approval of the respective transaction by at least a majority of the respective computing devices, the device is configured to record the respective transaction on the distributed ledger.

### PRIORITY CLAIM

The present application claims priority to U.S. Provisional Patent Application No. 63/567,179, filed on Mar. 19, 2024, the contents of which are incorporated herein by reference.

### TECHNICAL FIELD

The present disclosure generally relates to new approaches to providing a distributed system of computing devices which can be used for any database, distributed blockchain ledgers or other applications. A blockchain network can be operated in a more resilient and recoverable way utilizing a structured overlay framework in which each node in the blockchain network is part of at least two different neighborhoods.

### BACKGROUND

Blockchain networks implement generally a consensus protocol to enable transactions that are to be recorded on a set of identical local ledgers distributed across a network. The consensus protocol involves multiple computing devices, each running the consensus protocol software or module, to agree to the transaction and approve so that a majority or all of the possible voting devices agree to the transaction. To achieve the consensus, a sufficient amount of messaging needs to occur and according to a traditional transmission control protocol (TCP) or may use other inter-process communication protocols such as the User Datagram Protocol (UDP) or Quick UDP Internet Connections (QUIC) TCP. In some of these protocols, the data message transmitted from one computer to another computer needs to provide an acknowledgement (ACK) return message.

These confirmation messages in the context of blockchain networks and the required amount of communication to achieve consensus, results in a large messaging load that is needed to perform a consensus of transactions. Providing a guarantee of message delivery via the ACK message can slow down the system dramatically. A flooding technique involves propagation a message from one node of a network to another node and dramatically increasing a probability of successful message delivery to each node using fast connectionless communication methods.

### BRIEF DESCRIPTION OF THE FIGURES

To provide a more complete understanding of the present disclosure and features and advantages thereof, reference is made to the following description, taken in conjunction with the accompanying drawings, in which:

FIG. 1 illustrates a general blockchain network representing different nodes each communicating with each other, according to some aspects of the present disclosure;

FIG. 2A illustrates how a first subset of nodes defines one neighborhood out of a larger set of nodes, according to some aspects of the present disclosure;

FIG. 2B illustrates how a second subset of nodes defines one neighborhood out of a larger set of nodes, according to some aspects of the present disclosure;

FIG. 2C illustrates how a third subset of nodes defines another neighborhood out of a larger set of nodes, according to some aspects of the present disclosure;

FIG. 3 illustrates a transaction waterfall or series of operations for new transactions across the blockchain network, according to some aspects of the present disclosure;

FIG. 4 illustrates a messaging input approach for each node, according to some aspects of the present disclosure;

FIG. 5 illustrates a judicial protocol overview, according to some aspects of the present disclosure;

FIG. 6A illustrates an overview of a node start-up or synchronization approach, according to some aspects of the present disclosure;

FIG. 6B illustrates a more detailed approach to the node start-up or synchronization approach, according to some aspects of the present disclosure;

FIG. 7 illustrates a process of node inputs at each node, according to some aspects of the present disclosure;

FIG. 8 illustrates the processing by an incoming container operating at each node, according to some aspects of the present disclosure;

FIG. 9 illustrates the processing by a preframe container operating at each node, according to some aspects of the present disclosure;

FIGS. 10A-H illustrate the processing by a voting container operating at each node, according to some aspects of the present disclosure;

FIG. 11 illustrates the processing by a ledger commitment component operating at each node, according to some aspects of the present disclosure;

FIG. 12 illustrates an example method, according to some aspects of the present disclosure;

FIG. 13 illustrates an example method, according to some aspects of the present disclosure;

FIG. 14 illustrates an example method, according to some aspects of the present disclosure; and

FIG. 15 illustrates an example computing device or network device suitable for, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Disclosed herein are systems, methods and computer-readable storage media for operating a blockchain network in a more resilient and recoverable way utilizing a structured overlay framework in which each node in the blockchain network is part of at least two different neighborhoods. In the blockchain network, each node is independent and identical and all votes according to the consensus protocol are equal. There is no “leader” in the voting process and all votes are initiated by all nodes individually. All active nodes validate transactions and participate in consensus such that the consensus process is fully democratic. All decision on the blockchain network require a consensus and the decisions are final in that the distributed identical ledger provide an immutable record that persists forward.

This overview is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The approach disclosed herein addresses several points raised above. One aspect of this disclosure introduces a network topology in which each node or computing device in a set of networked computing devices belongs to more than one assigned neighborhood of computing devices or nodes. Messages are processed in a new way according to this network topology. When a respective compute device receives a message, it transmits the message to each of its neighbors which are spread across at least two different neighborhoods. The respective compute device in one aspect may not transmit the message to the one neighbor computing device that transmitted the message to the respective compute device. The approach disclosed herein reduces total number of messages produced while providing a guarantee of 100% coverage of the set of networked computing devices. In some cases, a gap fill protocol ensures request/response of any transactions that were not received via a flooding technique.

In some aspects, the techniques described herein relate to a system, including: a set of networked computing devices configured in a multiple-neighborhood topology, each respective computing device of the set of networked computing devices being configured as part of the multiple-neighborhood topology in which each respective computing device is assigned to a group of neighborhoods and follows a topology protocol to yield a respective assigned group of neighborhoods for the respective computing device, wherein each respective neighborhood of the group of neighborhoods includes a different subset of the set of networked computing devices in which the different subset of the set of networked computing devices only communicates with other computing devices in its respective assigned group of neighborhoods; a respective ledger operating on each respective computing device for recording transactions, wherein a combination of each respective ledger on each respective computing device includes a distributed ledger; a respective consensus algorithm running on each respective computing device such that when a respective transaction of a group of transactions is to be made via application of the respective consensus algorithm, a set of rules according to a transaction protocol applies in order for the respective transaction to be recorded on the distributed ledger, wherein the transaction protocol includes a combination each operation of each respective consensus algorithm on each respective computing device and further includes: receiving, at a first computing device in a first neighborhood, the respective transaction to be recorded on the distributed ledger across the set of networked computing devices; communicating the respective transaction to each neighbor of the first computing device, wherein each neighbor of the first computing device includes the respective assigned group of neighborhoods for the first computing device; continuing to communicate the respective transaction from neighborhood to neighborhood in the set of networked computing devices according to the multiple-neighborhood topology until all computing devices of the set of networked computing devices have received the respective transaction; and upon approval of the respective transaction by a respective vote from at least a majority of computing devices of the set of networked computing devices, recording the respective transaction on the distributed ledger; and a respective judicial module operating a respective judicial protocol on each respective computing device, wherein fault detection occurs via application of the respective judicial protocol in which a majority of computing devices in a respective neighborhood can take an action against a faulty computing device of the respective neighborhood by determining that the faulty computing device violates one or more rule of the set of rules.

In some aspects, the techniques described herein relate to a method of connecting a new respective computing device to a set of networked computing devices configured in a multiple-neighborhood topology, the method including: receiving a verified approved configuration of all computing devices in a group of neighborhoods that the new respective computing device is part of in the multiple-neighborhood topology; announcing, from the new respective computing device, a current state to the group of neighborhoods; if the current state indicates that there is missing activity with respect to a distributed ledger of which the new respective computing device has a respective local ledger as part of the distributed ledger, then working with the group of neighborhoods to request the missing activity to update the respective local ledger on the new respective computing device, wherein previously unknown transactions received during a synchronization process must successfully reach consensus to be accepted.

In some aspects, the techniques described herein relate to a method including: implementing a topology protocol operating on each respective computing device of a set of networked computing devices configured in a multiple-neighborhood topology, each respective computing device of the set of networked computing devices: (1) being configured as part of the multiple-neighborhood topology in which each respective computing device is assigned to a group of neighborhoods and (2) following a topology protocol to yield a respective assigned group of neighborhoods for the respective computing device, wherein each respective neighborhood of the group of neighborhoods includes a different subset of the set of networked computing devices in which the different subset of the set of networked computing devices only communicates with other computing devices in its respective assigned group of neighborhoods; operating the set of networked computing device such that a new transaction received at each respective computing device is processed by the respective computing device by operations including: confirming a valid signature of the new transaction and generating a condition for the new transaction to generate a stamped transaction; transmitting the stamped transaction to the respective assigned group of neighborhoods for the respective computing device using an unacknowledging delivery protocol; ordering the stamped transaction with other new transactions according to respective conditions on the other new transactions to yield an ordered list of new transactions; waiting a time delay; generating a preframe based on the ordered list of new transactions; transmitting the ordered list of new transactions to the respective assigned group of neighborhoods for the respective computing device; receiving a respective proposed ordered list of new transactions from each of the respective assigned group of neighborhoods for the respective computing device; comparing the ordered list of new transactions to the respective proposed ordered list of newt transactions to yield a comparison; when the comparison achieves consensus amongst each neighborhood of the respective assigned group of neighborhoods for the respective computing device, submitting the ordered list of new transactions to a ledger container; and applying, via the ledger container, the list of new transactions to an immutable ledger operating on the respective computing device.

In some aspects, the techniques described herein relate to a method of managing a transaction lifecycle on a node of a blockchain network having a topology protocol operating on each respective node of a set of networked nodes configured in a multiple-neighborhood topology, each respective node of the set of networked nodes: (1) being configured as part of the multiple-neighborhood topology in which each respective node is assigned to a group of neighborhoods and (2) following a topology protocol to yield a respective assigned group of neighborhoods for the respective node, wherein each respective neighborhood of the group of neighborhoods includes a different subset of the set of networked nodes in which the different subset of the set of network nodes only communicates with other nodes in its respective assigned group of neighborhoods, the method including: receiving a new transaction request from one of a wallet or another node; collecting all new transaction requests older than a time delay into a collection of new transaction requests; grouping the collection of new transaction requests in an order to generate a preframe; broadcasting the preframe to the group of neighborhoods assigned to the node; voting as part of a consensus algorithm with other nodes of the group of neighborhoods assigned to the node on a content and an order of the collection of new transaction requests in the preframe to yield a vote; when, based on the vote or other votes of the nodes of the group of neighborhoods assigned to the node, a consensus is reached, submitting the collection of transactions in the preframe to an immutable ledger.

In some aspects, the techniques described herein relate to a computing device operating a blockchain network having a topology protocol operating on each respective computing device of a set of networked computing device configured in a multiple-neighborhood topology, each respective computing device of the set of networked computing devices: (1) being configured as part of the multiple-neighborhood topology in which each respective computing device is assigned to a group of neighborhoods and (2) following a topology protocol to yield a respective assigned group of neighborhoods for the respective computing device, wherein each respective neighborhood of the group of neighborhoods includes a different subset of the set of networked computing devices in which the different subset of the set of networked computing devices only communicates with other computing devices in its respective assigned group of neighborhoods, the computing device including: an incoming message queue configured to receive a new transaction, confirm the new transaction and apply a stamp to the new transaction to yield a stamped transaction; a judicial component that causes the new transaction to be discarded if the new transaction is at least one of improperly formed, does not have a valid signature, or does not have a valid fee; an incoming container that receives the stamped transaction and broadcasts the stamped transaction to the respective assigned group of neighborhoods for the computing device and generates an ordered set of new transactions including the stamped transaction and other stamped transactions; a preframe container that generates a preframe including the ordered set of new transactions and broadcasts the preframe to the respective assigned group of neighborhoods for the computing device; a voting container that receives the preframe from the preframe container, receives other preframes from the respective assigned group of neighborhoods for the computing device and votes on a content of the preframe and the other preframes and an order of transactions in the other preframes to yield a vote associated with a consensus; and a ledger container that when the preframe and other preframes meet the consensus among a majority of computing devices in the respective assigned group of neighborhoods for the computing device, adds the preframe to a ledger operating on the computing device.

In some aspects, a system connecting a new respective computing device to a set of networked computing devices configured in a multiple-neighborhood topology is disclosed. The system can include: at least one processor; and a computer-readable storage medium storing instructions which, when executed by the at least one processor, cause the at least one processor to be configured to: receive a verified approved configuration of all computing devices in a group of neighborhoods that the new respective computing device is part of in the multiple-neighborhood topology; announce, from the new respective computing device, a current state to the group of neighborhoods; if the current state indicates that there is missing activity with respect to a distributed ledger of which the new respective computing device has a respective local ledger as part of the distributed ledger, then work with the group of neighborhoods to request the missing activity to update the respective local ledger on the new respective computing device, wherein previously unknown transactions received during a synchronization process must successfully reach consensus to be accepted.

In some aspects, a system can include: at least one processor; and a computer-readable storage medium storing instructions which, when executed by the at least one processor, cause the at least one processor to be configured to: implement a topology protocol operating on each respective computing device of a set of networked computing devices configured in a multiple-neighborhood topology, each respective computing device of the set of networked computing devices: (1) being configured as part of the multiple-neighborhood topology in which each respective computing device is assigned to a group of neighborhoods and (2) following a topology protocol to yield a respective assigned group of neighborhoods for the respective computing device, wherein each respective neighborhood of the group of neighborhoods comprises a different subset of the set of networked computing devices in which the different subset of the set of networked computing devices only communicates with other computing devices in its respective assigned group of neighborhoods; operate the set of networked computing devices such that a new transaction received at each respective computing device is processed by the respective computing device by operations comprising: confirming a valid signature of the new transaction and generating a condition for the new transaction to generate a stamped transaction; transmitting the stamped transaction to the respective assigned group of neighborhoods for the respective computing device using an unacknowledging delivery protocol; ordering the stamped transaction with other new transactions according to respective conditions on the other new transactions to yield an ordered list of new transactions; waiting a time delay; generating a preframe based on the ordered list of new transactions; transmitting the ordered list of new transactions to the respective assigned group of neighborhoods for the respective computing device; receiving a respective proposed ordered list of new transactions from each of the respective assigned group of neighborhoods for the respective computing device; comparing the ordered list of new transactions to the respective proposed ordered list of new transactions to yield a comparison; when the comparison achieves consensus amongst each neighborhood of the respective assigned group of neighborhoods for the respective computing device, submitting the ordered list of new transactions to a ledger container; and applying, via the ledger container, the list of new transactions to an immutable ledger operating on the respective computing device.

In some aspects, a system is disclosed that manages a transaction lifecycle on a node of a blockchain network having a topology protocol operating on each respective node of a set of networked nodes configured in a multiple-neighborhood topology, each respective node of the set of networked nodes: (1) being configured as part of the multiple-neighborhood topology in which each respective node is assigned to a group of neighborhoods and (2) following a topology protocol to yield a respective assigned group of neighborhoods for the respective node, wherein each respective neighborhood of the group of neighborhoods comprises a different subset of the set of networked nodes in which the different subset of the set of network nodes only communicates with other nodes in its respective assigned group of neighborhoods. The system can include: at least one processor; and a computer-readable storage medium storing instructions which, when executed by the at least one processor, cause the at least one processor to be configured to: receive a new transaction request from one of a wallet or another node; collect all new transaction requests older than a time delay into a collection of new transaction requests; group the collection of new transaction requests in an order to generate a preframe; broadcast the preframe to the group of neighborhoods assigned to the node; vote as part of a consensus algorithm with other nodes of the group of neighborhoods assigned to the node on a content and an order of the collection of new transaction requests in the preframe to yield a vote; when, based on the vote or other votes of the nodes of the group of neighborhoods assigned to the node, a consensus is reached, submit the collection of transactions in the preframe to an immutable ledger.

The foregoing, together with other features and embodiments, will become more apparent upon referring to the following specification, claims, and accompanying drawings.

### Example Embodiments

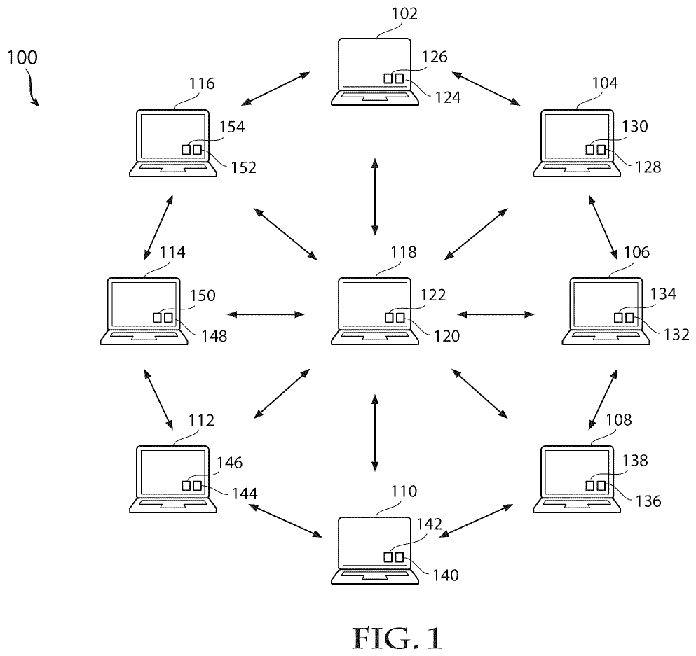

FIG. 1 illustrates a general blockchain network representing different nodes each communicating with each other, according to some aspects of the present disclosure. The blockchain network 100 includes a plurality of distributed nodes or computing devices 102, 104, 106, 108, 110, 112, 114, 116, 118. Each of these nodes and computing devices includes a component, module or software as part of a distributed consensus algorithm 120, 124, 128, 132, 136, 140, 144, 148, 152 a part of a distributed consensus algorithm in which transactions that are to be processed by the blockchain network are voted upon by the distributed consensus algorithm. Blockchain networks 100 have various consensus mechanisms or related techniques, including proof of stake, game theory, direct acyclic graph tangle (DAG) consensus, leader election-based consensus, and practical Byzantine fault tolerance (PBFT). Other techniques related to consensus mechanisms include a multisignature requirement which is a cryptographic assumption technique to validate a submission to a consensus mechanism. Other approaches to consensus are also provided herein.

Another component, module or software provide a distributed ledger 122, 126, 130, 134, 138, 142, 146, 150, 154. The general operation of the blockchain is that it will record across the distributed identical ledgers 122, 126, 130, 134, 138, 142, 146, 150, 154 transactions that are voted upon by the consensus algorithm 120, 124, 128, 132, 136, 140, 144, 148, 152. The recorded transactions (such as a dex smartcontract, or transfer of a cryptocurrency, or a confirmation of an event or of a validity of a document), are immutable in that the way the distributed ledger works is through adding to the ledger or a hashed-linked list individual transactions in which each block is connected via a hash to data in a previous block. The blockchain network 100 is a distributed database that maintains a continuously growing list of ordered records, called blocks. The blocks are linked using cryptography. Each block contains a cryptographic hash of the previous block, a timestamp, and transaction data. The blockchain network 100 is a decentralized, and can include distributed and public or private digital identical ledgers that are used to record transactions across many computers so that the record cannot be altered retroactively without the alteration of all subsequent blocks and the consensus of the network. Once a transaction is recorded and added to the chain, it is extremely difficult to alter that information without changing all subsequent blocks. The data regarding a transaction proceeds through a transition from one state (the pre-ledger state) which could be hacked or shared to another state (a post-ledger state) in which the transaction or data is immutable to the extent that the transaction cannot be altered without the consensus of the blockchain network 100. These characteristics cannot be obtained via a generic computer storing data in a memory. In such a case, the structure of a generic computer does not enable immutable storage of data on the memory of the computer.

The blockchain network 100 can be used to record data or transactions related to a number of different use cases. For example, real work asset tokenization, stable coins, multi-play game coordination, are some examples. The following is a non-limiting summary of the other different adaptations for the use of the blockchain network 100:

(1) Blockchain for payment processing and money transfers. Transactions processed over a blockchain could be settled within a matter of seconds and reduce (or eliminate) banking transfer fees. (2) Blockchain for monitoring of supply chains. Using blockchain, businesses could pinpoint inefficiencies within their supply chains quickly, as well as locate items in real time and see how products perform from a quality-control perspective as they travel from manufacturers to retailers. (3) Blockchain for digital IDs. Some companies are experimenting with blockchain technology to help people control their digital identities, while also giving users control over who accesses that data. (4) Blockchain for data sharing. Blockchain could act as an intermediary to securely store and move enterprise data among industries. (5) Blockchain for copyright and royalty protection. Blockchain could be used to create a decentralized database that ensures artists maintain their music rights and provides transparent and real-time royalty distributions to musicians. (6) Blockchain for Internet of Things network management. Blockchain could become a regulator of IoT networks to identify devices connected to a wireless network, monitor the activity of those devices, and determine how trustworthy those devices are and to automatically assess the trustworthiness of new devices being added to the network, such as cars and smartphones. (7) Blockchain for healthcare. Blockchain could also play an important role in healthcare. Healthcare payers and providers are using blockchain to manage clinical trials data and electronic medical records while maintaining regulatory compliance.

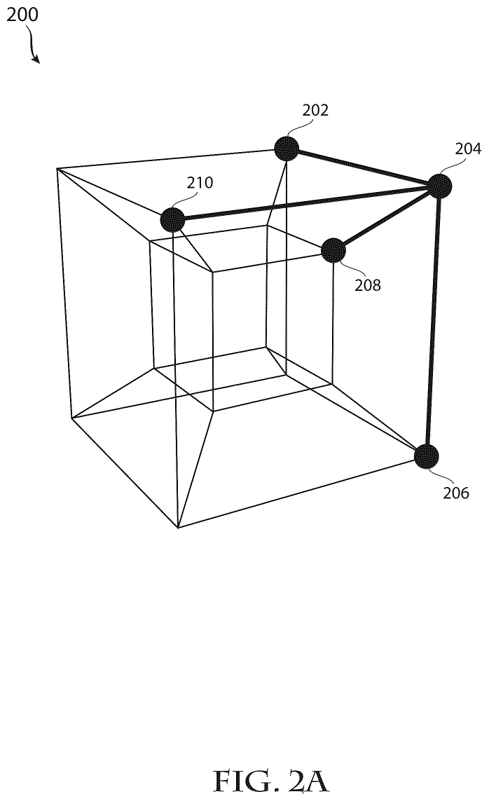

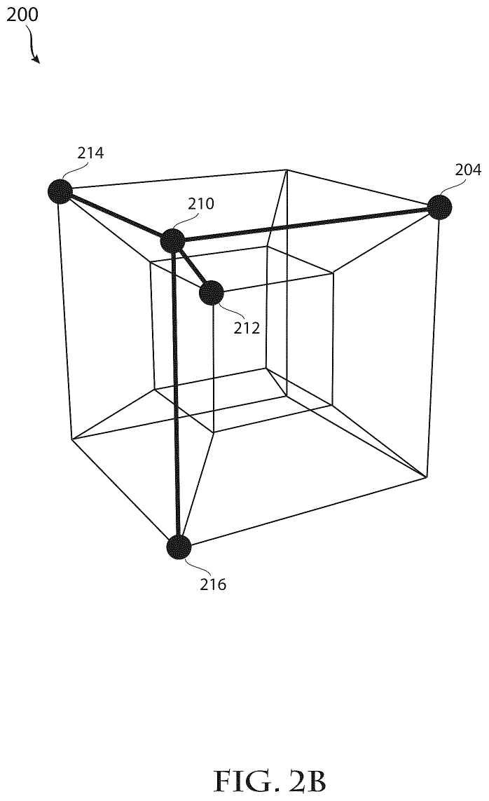

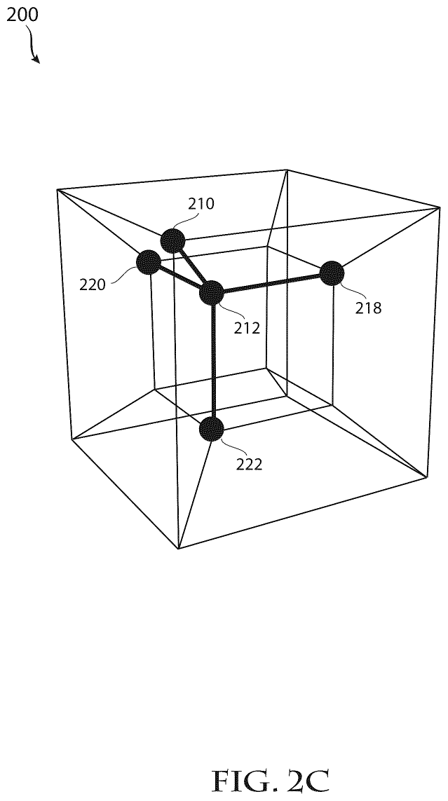

While FIG. 1 illustrates a general blockchain network, the specific structure of the blockchain network disclosed herein include additional features. FIG. 2A illustrates how a first subset of nodes defines one neighborhood out of a larger set of nodes 200. The present disclosure includes a topology overlay network in which each node is part of at least two “neighborhoods” of nodes. A hypercube is one non-limiting example of the potential network topology that can be used.

In one example, a node 210 in FIG. 2A can be connected to nodes 202, 204, 206 and 208. This is one neighborhood. One aspect of the neighborhood is that the structure in the set of nodes 200 can have as minimal a diameter as possible based on an overall number of nodes. As each node should be a member of at least two different neighborhoods, FIG. 2B illustrates how a second subset of nodes defines another neighborhood out of the larger set of nodes 200. Here, node 210 is also part of a second neighborhood including nodes 212, 214, 216 and 204. Each set of nodes that are connected in this way define a neighborhood and as noted above, each node should be part of two or more neighborhoods. The neighborhoods are heavily connected in that they can achieve acceptable high level of reliability and optimization in a process of message delivery. The message delivery mechanism is one with low overhead or that is unreliable in that no acknowledgment (ACK) messages are returned between nodes for messages sent. One example protocol is the UDP (User Datagram Protocol) but other protocols may be used as well.

FIG. 2C illustrates yet another neighborhood in the blockchain network 200 in which node 210 is part of a neighborhood including nodes 212, 220, 218, 222. The blockchain network 200 can be a distributed ledger network or a distributed database. The number of neighborhoods that any given node (Node 210 in this example) can vary and should in one aspect be at least two neighborhoods. In another aspect, there may be some nodes associated with a single neighborhood as well.

The neighborhood structured overlay enables consensus to be determined within a local neighborhood. The neighborhoods utilize the redundant connections of the overlay to achieve a network wide consensus. The details of the signaling or messaging within this structure is disclosed in more detail herein. The transaction waterfall 300 involves procedures and rules that each node must follow to actively participate in the processing, voting and persistence of the immutable distributed ledger.

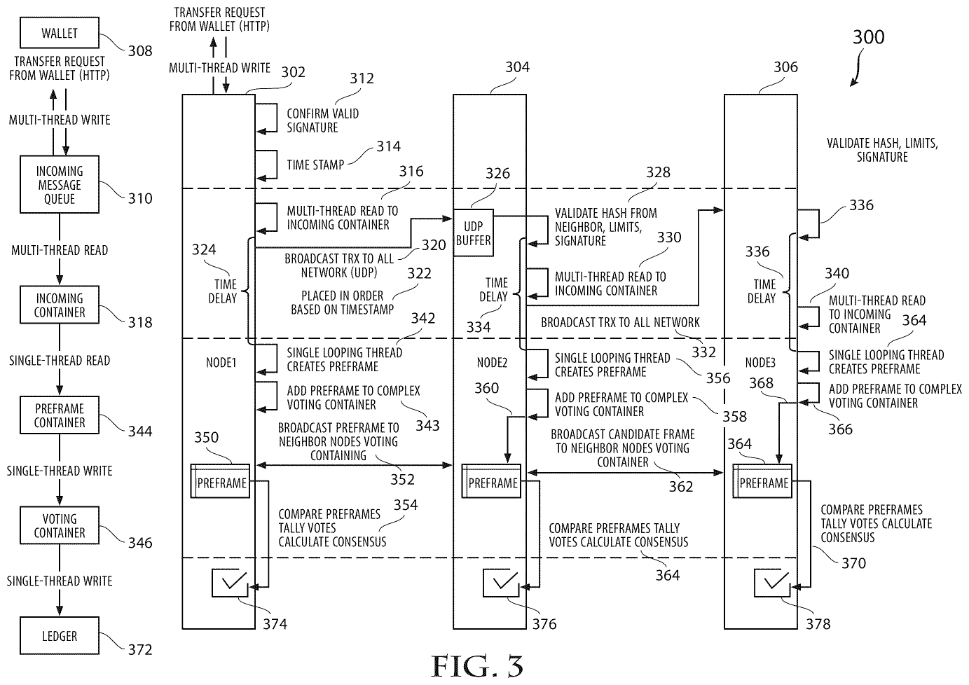

FIG. 3 illustrates a transaction waterfall or series of operations 300 for new transactions across the blockchain network, according to some aspects of the present disclosure. The transaction waterfall 300 involves procedures and rules that each node must follow to actively participate in the processing, voting and persistence of the immutable distributed ledger.

In FIG. 3, the flow of processing that occurs for a first node 302, a second node 304 and a third node 306 are shown. The process is by way of example the flow that begins with a transfer request from a wallet 308 that is received at the first node 302. The first node 302 represents any node in the network that receives a transfer request and shows how the transaction “waterfall” occurs as messages flow from the receiving node 302 to other nodes in its neighborhood.

Some or all of the processing could occur for other messages as well besides a transfer request from a wallet via an HTTP connection or other protocols as well. The process is representative of the various containers or components that are configured on each node in the network. Since each node is independent and essentially identical in function and operation, the process disclosed can occur in a similar manner on any node that receives a transaction or transfer request. The overall process includes data transmitted via a multi-thread write operation to an incoming message queue 310. The incoming message queue 310 operating on the first node 302 will confirm that the transfer request has a valid signature 312 and provide a time stamp 314 for the transfer request to generate or yield a stamped request. The transfer request should be properly signed with a valid signature from the sending address. The stamped request is transmitted through a multi-thread read 316 to an incoming container 318. The incoming container 318 handles new transaction requests that are received directly from wallets or from neighbor nodes 304, 306. A multi-threaded process collects all transactions older than a time delay that is aged to create and propagate pre-frames and initiate the voting.

The stamped request is broadcast 320 to all other nodes in one or more of the neighborhoods associated with the first node 302. The stamped request is received at a buffer 326 and the second node 304. The second node 304 validates a hash from the neighbor, limits, and a signature 328. The limits can be transaction fee upper and lower bounds, in one example. The second node 304 performs a multi thread read to its incoming container 330. There is a time delay 324 operating on the first node 302 which starts after the multi thread read to the incoming container 316. The incoming container 316 can be a first-in-first-out queue ordered according to the timestamp 314. Once the transaction has passed the valid signature stage 312, the individual transaction is broadcast 320 to all its neighbors. A time delay 334 on the second node 304 begins right before the second node 304 validates a hash from the neighbor, limits, and the signature 328. The second node 304 multicasts a message to all its neighbors 332 which are represented by the third node 306. The second node 304 can rebroadcast to its neighbors except to the sending node 302. The third node 306 validates a hash, limits and a signature from the second node 304 in operation 336. A time delay 338 starts right before the validation of the hash, limits and signature. The third node 306 performs a multi thread read to its incoming container 340.

The time delay can be set, for example, at two seconds, for the broadcasting to take place in terms of the individual transaction to reach all nodes in the network. That time can be fixed or can be flexible. For transaction that are aging (guaranteed time of transaction propagation across whole network), a time can be calculated and managed by a judicial protocol. A node configuration file or the judicial layer 502 can have that time delay data and circumstances may cause the time delay to change to be a longer time or a lower time. For example, the judicial layer 502 may determine through its AI self-learning engine 504 that the time delay can be reduced by the judicial layer 502 for example when the performance of the network improves and it only takes one or two seconds for the individual transactions to reach all of the nodes in the network or the outer bounds of the network. Thus, the time delay value at each node may change. Collected statistics across all fluctuations of the global network environment can be used to train the AI self-learning engine 504.

The first node 302 then performs a multi looping thread and creates a preframe 342 using its inbound container 344. to group eligible transactions for distribution. The preframe is a way to group together a collection of information ready for voting. In one example, the approach is to group together a collection of transactions for efficient distribution to neighbors. The preframes are multicast out to the neighbors, which identifies what the node 302 asserts is the order that these transactions should be in and puts that preframe in its voting container 346 and here is my vote. The eligible transactions are those transactions or as many transactions as it can find, that are older than the time delay 324. In a multi-threaded approach, the preframe container 344 multicasts the preframes to neighbors for transactional voting. The first node 302 adds 343 the preframe to a complex voting container 346. The voting container 346 is shown receiving a multi-thread write from the preframe container neighbor 344. The voting or consensus container 344 manages the voting process among neighborhood nodes. The nodes vote based on the contents and order of the transaction request. The submitted transactions that achieve consensus are sent to the commit queue as candidate to the ledger and if it succeeds through the validation blocks (like check balances for tokens, etc.) the transaction gets committed to the ledger container 372.

In one scenario, the preframe in the voting container 346 of node 302, it may relate to eight transactions. But then, if the votes or the preframes from other nodes may refer to nine transactions. The numbering of 8 vs 9 may be adjusted to refer to transactions being that number for reference instead of the number of transactions included in the preframe. In some aspects, the node 302 may recognize that it is receiving votes for transactions in preframe that it has not seen (transaction number nine). In that case, the node 302 can query its incoming container to see if there is transaction nine in that container which did not make it into the preframe currently in the voting container 346. If so, then the node 302 can bring transaction nine into the voting container so that it can vote on the package of nine transactions sent from other nodes in the network.

For voting purposes, node splitting received preframes to individual transactions and queueing them in the order of transactions content can occur. If a first transaction in the queue doesn't get decisive votes from the neighbors for reasonable time, the consensus algorithm doesn't jump to the next transaction in the ordered queue until it resolves the issue with the first one by re-requesting neighbors for the vote for this specific transaction. If for some reason node still unable to resolve it, node goes down for following investigation, fix and restarting.

In some aspects, there may be a sleep time after a component receives preframes for processing.

Operation 350 shows the first node 302 adding the preframe to the complex voting container 346. The first node 302 broadcast is preframe to neighboring nodes voting containers 352. The second node 304 performs a multi looping thread to create its preframe 356. It adds its preframe to its complex voting container 358 as shown in operation 360. The second node 304 broadcasts its candidate frame to neighbor nodes voting containers 362. The third node 306 performs a single looping thread operation to create its preframe 364 and adds its preframe to its complex voting container 366 as shown in operation 368.

The voting container 346 can be used to accommodate the fact that the processing is asynchronous. Different nodes will have, in one aspect, different timings as they vote on individual transactions contained in the voting container on their node and then share the preframe vote. As nodes receives votes and it reviews transactions in the voting container 346 and applies that vote. It will put the neighbor's vote in the voting container to see if the vote matches the node's vote (for node 302). The node 302 gets these votes from neighbors as defined by a benchmark (i.e., such as greater than 50% of the neighbors) and determines whether consensus is reached. For example, the node 302 may indicate that more than fifty percent of the nodes in my neighbors agree of the order of the transactions in the preframes. The “consensus” can be a flexible threshold and may require, for example, 60% or 70% of the nodes or any other desired values.

The first node 302 compares tally votes to calculate a consensus 354 as part of the operation of the voting container 346. The second node 304 compares its preframe tally votes to calculate a consensus 364 and the third node compares its preframe tally votes to calculate a consensus 370. If a majority of nodes within each neighborhood votes in favor of a group of transfer requests or transactions, then via a single thread right, the group of preframes is transmitted to a ledger 372 for recording on the distributed ledger. A frame ID is generated for a frame of data that will be written to the blockchain. Thus, the concept of the transactions in a “preframe” for voting and processing and then once consensus is made, the data becomes a “frame” of transactions having achieved consensus. The frame ID is the first identifier that pertains the grouping of transactions in the preframe having say 8 transactions that are now confirmed as meeting consensus and thus constitute a frame for recording on the ledger. The frame ID will also refer to a previous frame ID as is used in blockchain technology to link the blocks together. The pre-frame format is in one sense a package for compact transmission. Voting happens on “per transaction” basis and successful transactions get to the commit queue and get to the ledger only if they passed final validation such as sufficient balance for a token sub-chain or token name existence for transfer in a fungible token sub-chain.

The ledger container 372 implements a single-threaded processes for transactions that passed consensus to be applied to the immutable ledger. A single-threaded process can perform a final validation of the transaction including a final balance validation (associated with the fees) and can place the confirmed transaction into a storage frame. Frames consist of a fixed number of transactions that are bundled to provide optimization on nodes synchronization processes as well as to provide additional security on the validity of the ledger. Each ledger frame is assigned a unique identifier and maintains an association with the previous ledger frame in the ledger chain as its “parent”. Each ledger frame will become a parent of the next ledger frame when it is committed.

The ledger container 372 can also confirm that the transaction is not a duplicate transaction, that there is enough balance for the transaction and fees and then can add the transaction to the ledger. The first node 302 has its instances of the ledger 374, the second node 304 has its instance of the ledger 376 and the third node 306 has its instance of ledger 378. In this manner, each node communicates transactions to other nodes within the neighborhood or neighborhoods that the node is part of. The consensus decision involving a majority of nodes is performed on a neighborhood basis. Thus, in one example, the node 210 of FIG. 2A will participate in obtaining consensus for all of the nodes in the first neighborhoods shown. The same node 210 can also participate in obtaining consensus for all of the nodes in the second neighborhood shown in FIG. 2B. Similarly, node 210 can participate in a consensus for all of the nodes in the third neighborhood shown in FIG. 2C.

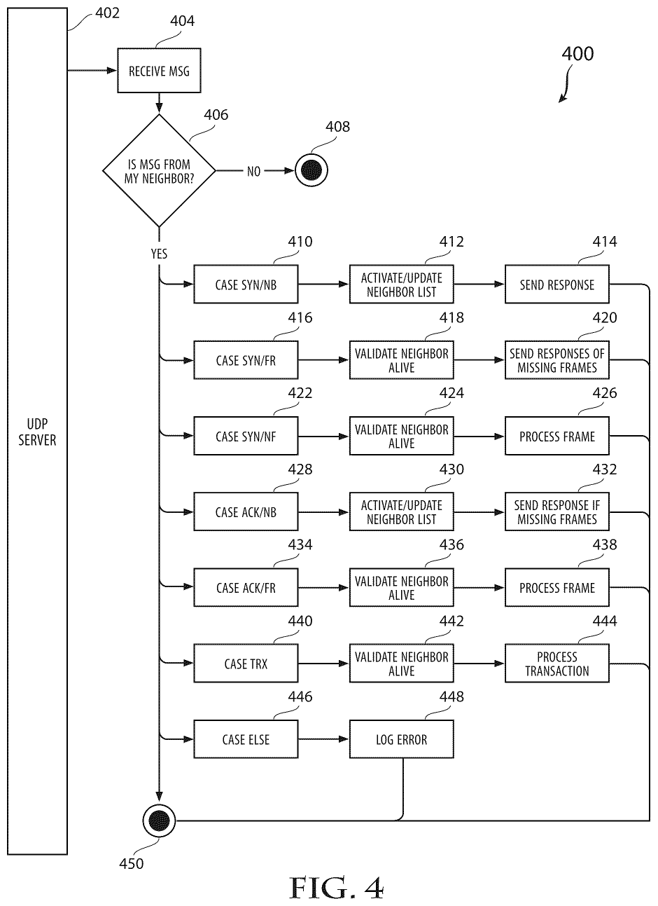

FIG. 4 illustrates a messaging input approach for each node 400. This illustrates the proper valid messages that can be received at a node 400. The UDP server 402 represents a component on the node that receives messages in an unreliable way such as through the UDP for example, any protocol that does not utilize the overhead to return acknowledgment signals (ACKs) when messages are received. The respective node 400 receives a message 404 and determines if the message is from one of the nodes in one or more of the respective node's neighborhoods. If not, then the message is discarded 408. If yes, then the node 400 continues to process the message as follows. There are different types of messages that can be processed in different ways. For example, a syn/nb message 410 (synchronize with neighbor's message) can relate to a node start-up or synchronization in which one node receives from another node the syn/nb 410 message. For that message, the response is to activate/update a neighbor list 412. The syn/nb message 410 tells the neighbors of the node that it is alive and here is the state of my ledger. The node 400 will respond 414 with the proper neighbor list or proper response to this type of message. The response 414 also tells the node 400 that the respective neighbor node is alive as well and can also provide information to the node regarding the state of its frame or ledger.

In the case of a syn/fr message 416 (synchronize frames message), which is a request to validate that the neighbor is alive 418 and to process a new frame which includes a group of transactions to be voted upon, the node 400 will send a response or responses of missing frames the requesting node may be missing 420. In the case of a syn/nf message 422, the node will validate that the neighbor is alive 424 and process a received frame 426. In the case of an ack/nb message 428 (acknowledgement from neighbors and/or current frame data message), the node 400 will active/update a neighbor list and send a response if the requesting node is missing frames 432. In the case of an ack/fr message 434 (acknowledge frame message that sends missing frames to a synchronizing node), the node 400 will validate that the neighbor is alive 436 and process a received frame. The ack/fr 434 message is typically transmitted from a node to a requesting node in response to a “syn/fr” message 416. In the case of a transmit signal 440, the node 400 will validate that the neighbor is alive 442 and process a transaction 444 into the distributed ledger. If the message type is anything else 446, the node 400 will log an error 448 and discard the message 450. In some cases, the message may be discarded from further processing but it may be logged if there is some relevance associated with the message.

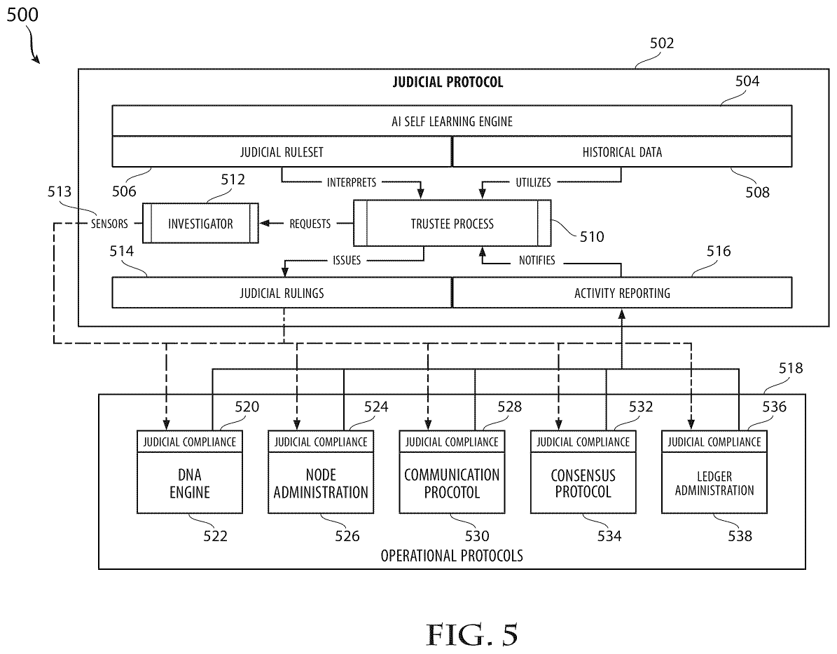

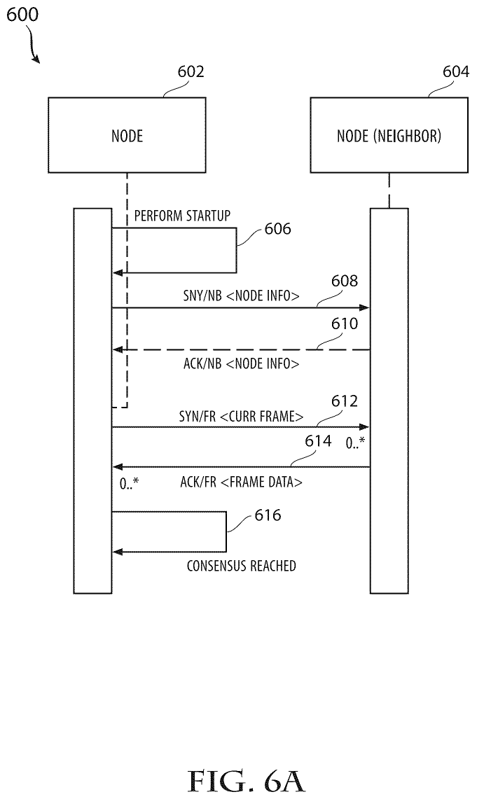

FIG. 5 illustrates a judicial protocol module 500. The judicial protocol module 500 can be operated by a separate node running software or a judicial protocol module 500. The judicial protocol module 500 defines a node operation guardrail and monitors operations to ensure the validity of node operations. The judicial protocol module 500 monitors interactions of a respective node with neighbor nodes to ensure that the requirements are all met. The judicial protocol module 500 implements mechanisms to identify and isolate non-compliant activities or any actions that violate the operational guardrails. The judicial protocol module 500 facilitates optimal network performance when node operators are unknown, faulty or malicious. The judicial protocol module 500 will execute responsibilities such as node punishments where appropriate.

The judicial protocol module 500 can include a number of different components. For example, a judicial protocol operating on a judicial module or layer 502 can include the operation of a self-learning engine 504 that includes a judicial ruleset 506 and the use of historical data 508. The self-learning engine 504 can be any type of machine learning engine or model that can utilize data for training and improve performance on various tasks related to judicial management of the network as disclosed herein. For example, the model or self-learning engine can use artificial intelligence, data mining, supervised learning, unsupervised learning, semi-supervised learning, or other types of learning and data acquisition to train the model to provide a proper output based on event reporting to the judicial layer 502. In other words, the self-learning engine 504 can include an artificial intelligence model that will learn through training data and/or actual live data how to make decisions according to the ruleset or guardrails regarding the various tasks needed to properly run the blockchain network. These tasks can include when to discard a message, when to remove a node from participating in the network due to performance or malicious activity, when to approve fees, when to provide data to a returning node for synchronization, when and how to allow a new node into the network, and so forth.

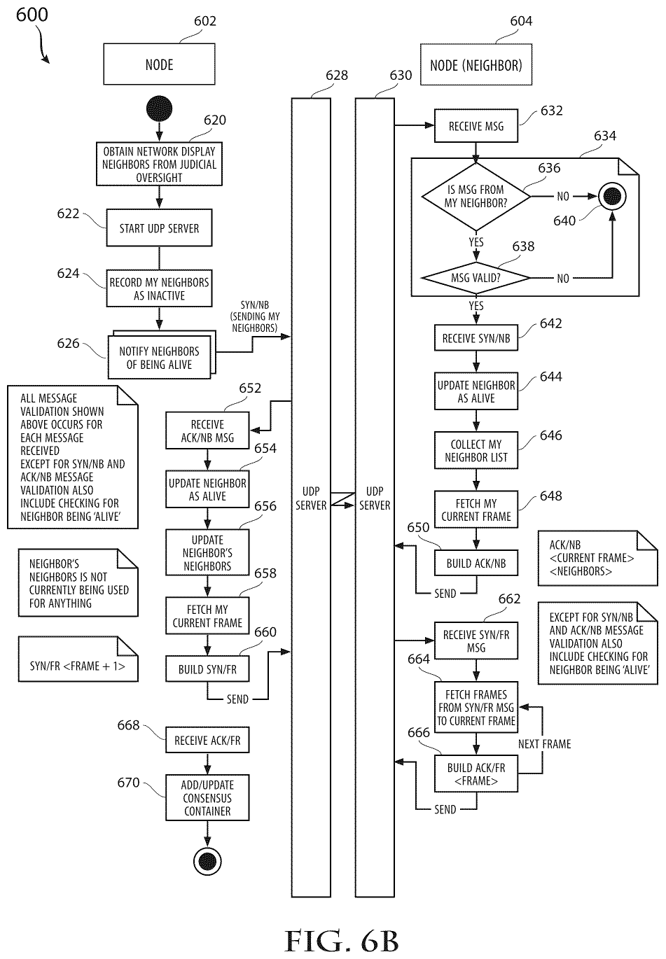

A trustee process 510 can make requests to an investigator 512 that can utilize sensors 513 that can determine judicial compliance from a number of different operational protocols 518 operating on each node in the blockchain network. For example, the different protocols 518 can include a self-replicating engine 522 that includes a component for enabling judicial compliance 520. The self-replicating engine 522 can include such information as the proper neighbors for a new node or a returning node to the network. The self-replicating engine 522 is aware of the overall network topology can perform an operation including adapting the network and the neighborhood structure for the incoming node. When a new node or a returning node desires to join the network it will receive the list of neighboring nodes from the DNA entire 522. The self-replicating engine 522 sits on the node but is isolated and can talk to the other self-replicating engine components on each other node in the network and the self-replicating engine 522 will communicate with other self-replicating engines to derive and come up with the proper topology that is then provided to the returning or new node 602 at step 620 of FIG. 6B.

One aspect of the self-replicating engine 522 can include adjusting the network topology (the structure of what nodes are in what neighborhoods) when a node goes down or is removed from the network. The self-replicating engine 522 knows what nodes are registered and active on the network. For example, if node 210 from FIGS. 2A, 2B and 2C were to be removed from participating in the network, then each of the other nodes would need to remain within or a part of a group of two or more neighborhood and there may need to be a realignment of the network topology. In this manner, once the consensus is reached on the new topology, the judicial layer 502 would need to communicate that new topology and the transfer or transition to the new set of neighbors for one or more nodes in the network. Thus, the network topology is a dynamically changing structure based on one or more of new nodes joining the network and nodes being removed from the network. In some cases, the decision on how to restructure that network topology can be based on the manner or type of change in a node. For example, a node that is merely underperforming and that needs a gap filling, penalty recovery or a software upgrade may be taken “off-line” but require no change in the network topology because it is expected that the node will be back on-line within a predetermined or predicted period of time. In another scenario, a hardware failure might be a more dramatic event that will require changing the network topology until the hardware fix is accomplished.

A node administration module 526 can have its component for enabling judicial compliance 524. The node administration module 526 can provide some of the data discussed herein such as target fee addresses, network topologies, and other requests for data that are disclosed herein. A communication protocol 530 can include its component for enabling judicial compliance 528. A consensus protocol 534 can include its component for enabling judicial compliance 532 and a ledger administration component 538 can include its component for enabling judicial compliance 536. The sensors 513 can determine through the various judicial compliance components whether a particular module or component of a node is operating properly and in accordance with the judicial ruleset 506. The trustee process 510 can utilize the historical data 508 to makes its determinations. The trustee process 510 interprets the judicial ruleset 506 and issues judicial rulings 4514. The various operational protocols 518 can provide via their respective judicial compliance component activity reporting 516 to the trustee process 510 for evaluation and judgement regarding its compliance with the guardrails or judicial ruleset.

The judicial layer 602 enforces transaction protocol rules that each node needs to follow to securely and reliably exchange information with neighboring nodes. Rules include confirming that a message is properly constructed and that communication rulesets are followed. The ordering of transactions associated with a request, frame or preframe needs to be proper or a message associated with the request, frame or preframe will be discarded. The procedures overall ensure a stable, consistent operation in an asynchronous environment. Further, the procedures guarantee that there will be a properly synchronized local ledger on each individual node and that each node verifies a proper signature of each transaction request.

FIG. 6A illustrates an overview 600 of a node start-up or synchronization approach 600. FIG. 6B will provide a more detailed flow relative to what is shown in FIG. 6A. A first node 602 in FIG. 6A is considered in one or two states. One may be where the node 602 is initially starting up and joining the blockchain network 100. Another state might be where the node 602 is synchronizing with the blockchain network because it was offline or not allowed to participate in the network for any reason. Nodes must follow the proper rules or guardrails to actively participate in the network. Each node must receive its verified, approved configuration of its neighbors. Upon start-up or synchronization, the node 602 will perform a startup operation 606 and announce its current state to its neighbors 604 via a message such as syn/nb <node info> message 608. The message “syn/nb” can represent a message to “synchronize with neighbors” message. The neighboring node will provide an ack/nb <node info> message 610 in return. If the node is not current in the sense that its local ledger may not have all of the transactions recorded thereon, it will generally work with its neighbors to request the missing activity. The node 604 represents a neighbor node which can be in a same neighborhood as the node 602. In order to synchronize, the node 602 will transmit a message such as a syn/fr <curr frame> message 612 to the node 604 which identifies its current frame and in one sense tells node 604 where the ledger on 602 is missing recent frames. The message is a request for the missing frames from the ledger of node 602 so that the node 602 can get current with its ledger. The node 602 will receive in a message such as an ack/fr <frame data> message 614 the previously unknown transactions organized into frame at the node 602. The previously unknown transactions that are received during synchronization must successfully reach consensus to be accepted and recorded on the ledger 616. The node 602 receives the unknown transactions from other neighbor nodes. The other neighbor nodes might also be at different stages. The transactions received from the neighbors from its latest frame to the current frame can vary. The node 602 will receive and process those unknown transactions using the consensus algorithm using the normal process. The normal processing can bring the node 602 to be current with the other neighbors at least to a point. Once the node 602 processes the unknown transactions—other transactions may also have been in process and the node 602 can then pick up and process the transactions received during the synchronization process.

During the synchronization process, once consensus is achieved, the transaction or transactions in a frame should be written to the ledger. If node 602 receives catchup transactions and processes it according to the normal consensus, it may vote “no” on a transaction, but if consensus was reached from its neighbors, and a majority or whatever threshold of votes has been met, then the node 602 should accept that as consensus and write the transaction to its ledger. The node 602 cannot make a determination on its own—it has to listen to its neighbors. The node 602 even during synchronization it cannot overrule or not listen to the consensus of its neighbors. In this sense, the process at the node 602 may be faster because a consensus is already reached from the neighbors for these transactions.

The guardrails can be characterized as judicial protocols implemented or enforced by the judicial layer 502 and which can be referenced or accessed in various places as disclosed herein. They judicial layer 502 enforces active monitoring and correction controls overseeing the node interactions with the network. The guardrails protect against malicious attack vectors, non-compliant messaging or underperforming neighbor nodes which can compromise the overall stability of the network.

FIG. 6B illustrates these processes 600 in more detail. As shown, at startup or synchronization, node 602 can obtain a list of network topology neighbors from a judicial oversight component or judicial layer 620. This can be, for example, one of the services provided by the judicial protocol module or judicial layer 502 shown in FIG. 5. The judicial layer 502 is a software layer operating on each respective node that can include the self-replicating engine 522 that corresponds with other self-replicating engines across the network on different nodes to vote on or arrive at a consensus of what the change in the network topology should be when a node joins the network or returns to the network. There may also be other places where this initial data can be provided such as through a properties file that is provided to the node 602.

The network topology can be received from the judicial layer 502 and the judicial layer 502 can work with the other nodes in the network to determine what that neighborhood topology should be given the introduction of a new node. There may be a consensus component to the operation of the judicial layer 502. This may also change when a node that previously was included in the network is synchronization after being down for a period of time. Thus, the network topology is not necessarily in one aspect just a report on what the topology (currently) is but might be a new topology that takes into account the introduction of a new node 602 into the blockchain network. Thus, one aspect of the nodes working together is the concept of a self-organizing realignment (from the self-replicating engine 522) to sustain and maintain an adequate overlay coverage across the entire network.

The node 602 can start up a UDP server 622 which can be any server or module that operates an unreliable communication protocol in that each message received does not necessarily need a responsive acknowledgement message which requires overhead. The UDP server 628 is shown separately as the component through which messages are transmitted and received to and from other neighbors 604. All communication between nodes is performed via UDP channels or use a channel that does not have a message delivery guarantee. Each node has one to several UPD servers 622. Each node 602 has a listening port for listening to other nodes for messages. The node 602 may record its neighbors as being inactive 624. The purpose of setting a state of its neighbors as being inactive is connected to a later step where a response from individual neighbors can enable the node 602 to update its list of active neighbors as alive (see step 654). The node 602 may notify its neighbors of being alive or coming back online 626 through the syn/nb message. Since the node 602 received the list of neighbors (which can be in one or more “neighborhood”), the node 602 notifies the neighbors in it list. The list of neighbors is found in the network topology received from the judicial layer 502 (and more specifically from the self-replicating engine 522 in connection with the judicial layer 502 which operates on the node 602) in step 620 by the node 602. The syn/nb message can include a number of pieces of information such as the state of the node 602 being inactive, a notice that the node 602 is alive and seeking synchronization, as well as other data. The neighbor node 604, via a UDP server 630 associated with the neighbor node 604, receives the message 632 and determines a set of questions 634 including first whether the message is from a neighbor 636 and whether the message is valid 638. If the answer is “no” to either of these queries, the message is discarded 640. The use of the UPD servers 628, 630 is one non-limiting example of using servers or protocol that are unreliable or that do not use overhead to confirm the receipt of messages. Any protocol can be used. The messages are formatted in a certain way which is recognized and evaluated by each neighbor to confirm a proper format. Node 604 can represent each neighbor's operational flow when receiving the syn/nb message and thus this process will occur for each neighbor in each of the multiple neighbors that the node 602 is associated with.

If the answer is “yes” to both of these queries 636, 638, the node 604 receives the syn/nb message 642 and updates a state of the neighbor node 602 as alive. The node 604 collects a list of neighbors 646 and fetches a current frame 648. For example, assume that the current frame for node 604 is frame number 105. This number will be relative to a further example below.

The node 604 builds an ack/nb message that can include such data as the current frame and its neighbors list and sends the ack/nb message 650 through the UDP server 630 to the node 602 via its UDP server 628. The node 602 receives the ack/nb message 652 and updates its neighbor as alive 654 and further updates the status of its neighbor's neighbors 656 and fetches its current frame 658. The node 602 can also build a syn/fr message 660 for sending via the UDP server 628 to the node 604 via its UDP server 630. The UDP server 628, 630 references a component that listens on a port for messages. The syn/fr message includes the “frame +1” which is the last completed frame of the node 602 (when it is not a brand new node joining the network but a synchronization of a node with some history with the network) plus 1. This means that the node 602 will notify the neighbor node 604 of the next frame it needs to synchronize which would be its last completed frame plus 1. For example, if the frame number is “100”, then node 602 knows of the ledger up to and including frame 100. If node 602 was working on adding frame 101 to the ledger and it went down part way through the process, then that frame 101 would not be fully committed to the ledger. Thus, by obtaining only what is fully committed to the ledger, node 602 can properly identify what the next transaction or frame it needs is. The node 602 needs to tell its neighbors that it needs to update its ledger starting at frame 101.

If node 602 is starting as a brand new node, in one aspect it may receive a snapshot of the ledger at a certain frame number and then synchronize from that point as described herein. In this scenario, the step 620 may include receiving from a judicial layer the snapshot of the ledger.

In another aspect, its ledger may be empty and it may simply start with frame 1 and synchronize. The frame 0 would likely be a genesis transaction which is the first transaction as the ledger is initiated. The synchronization process with respect to message flow is intensive and thus part of the process of onboarding a new node would be to seek to optimize a snapshot that is transmitted to the new node 602 that is as close to the current state of the ledger as possible. Thus, the system may perform an analysis of the state of the system, and the flow of data, and make a timing determination of when to take a snapshot of the ledger, pass that snapshot to the new node 602, and then have the node synchronize with the neighbors to update its ledger.

One variation of this approach includes the idea of a generis block. When a node starts up as a new node in a blockchain network, the new node needs to initiate the participation in the network by generating a genesis block in its ledger. The system (other nodes in its neighborhood) can check to see if the genesis block or genesis transaction exists at node start-up as a new node. Such a process may also occur upon synchronization as well but may particularly apply to a new node to the blockchain network.

When a new node starts up and is synchronizing, it has already notified its neighbors that it is alive, from that point forward, any new messages that are being considered are being transferred to the node 602. However, it's ledger is not yet current. So while it is receiving these new messages that are outside of the synchronization process. Thus, once the node 602 is synchronized, it has a backlog of transactions that it needs to vote on and process for adding to the ledger. But for a period of time, it is not current with the ledger. After its synchronization is complete and its ledger is updated, there may be, for example, 5 frames backup up on the node 602. When node 602 then creates its preframes for that set of transactions, it can then vote on and participate in the consensus process for all those buffered frames it received while it was synchronization is complete. In this sense, the node 602 simply catches up after synchronization with the other nodes for the transactions received during the synchronization.

The node 604 receives the syn/fr message 662 and validates the message including checking for the node 602 to be alive. The node 604 fetches frame from the syn/fr message to the current frame 664 and on a frame by frame basis, sends each frame needed by the node 602. Each frame can include a number of ordered transactions, such as, for example, eight transactions. Using the example above where node 602 needs to update its ledger from frame 101, the node 604 in step 664 will fetch its frames starting frame 101 and up to its current frame 105. The iteration between steps 664 and 666 involve the node 604 fetching the necessary frames starting at frame 101 to frame 105 to build the acknowledgement message with the frames to update the ledger for node 602. In one aspect, the ack/fr message generated in step 666 involves frames that were previously voted on by the neighboring nodes and added to their respective ledgers. In one aspect, step 666 involves transmitting the transaction information used to build one or more frames that the node 602 does not yet have on its ledger. However, since node 602 is returning to the network and needs to synchronize it sledger, the voting or consensus container process 670 needs to occur again for the node 602 to confirm that it is proper to add those frames to its ledger. The frames again represent the transaction information and thus node 602 will be receiving the necessary transaction information via the frames starting at frame 101 to update its ledger.

The node 604 builds an ack/fr <frame> message 666 and sends it to the node 602. The node 602 receives the ack/fr message 668 and adds or updates its consensus container 670 with the frame(s) (Frames 101-105) to proceed with the consensus process prior to recording the frame(s) on its ledger. These processes can include use of components such as the voting container 346 of FIG. 3 and applying the frame(s) to the ledger 372. The consensus container 670 involves the node 602 not trusting the one neighbor 604 as providing the true data. The consensus container 670 will cause the node 602 to receive the same data from its other neighbors. The vote will involve confirming that all of the neighbors providing the same frame data via a vote and if the consensus occurs, then those transactions will be written to the ledger. In one example with respect to timing, assume that node 602 has caught up or

synchronized up to frame 105. Then assume during that synchronization process, the rest of the network worked fast and got to frame 150 in the ledger. The node 602 will start voting on frame 106, 107, 108 when the neighbor nodes are voting on frames 151, 152, 153. An analysis of the system can occur to balance out the time involved for node 602 to catch up relative to the other nodes in the network and the current frame that they are voting on. Other nodes could go down, a prediction of the number of transactions that are going to occur over a period of time in the future, or other parameters might involve the system to let the node 602 to catch up or in one case to perform another synchronization for node 602 rather than letting the node 602 catch up. The system may involve having other neighbors to slow down or not. The system can implement different procedures to utilize a snapshot approach of the ledger or allow the new node 602 or synchronizing node to catch up. Machine learning models can be used to predict the performance of the network and to classify or predict what performance is expected and based on the output of the machine learning model, procedures can be implemented to be efficient in either a resynchronize operation or just to let the node 602 catch up on its voting process. Synchronization bypasses some of the container operations and can perhaps enable a quicker approach than letting the node 602 continue to catch up to buffered transactions during a first synchronization. The purpose is to quickly get the node 602 to the normal voting and processing state for participation in the blockchain network.

A system check can occur after synchronization to determine whether to perform another synchronization or whether to allow the node 602 to catch up through its normal voting process for buffered transactions it has already received. For example, since the node 602 has those transactions in its incoming container, it may be more efficient to just vote on and catch up to the current state of the ledger. The number of transactions may be too large and it may be more efficient to perform another synchronization to catch up. If another synchronization is the decision of the system, then the transactions in the incoming container would be dropped as the node 602 will receive those from the synchronization process from other frames.

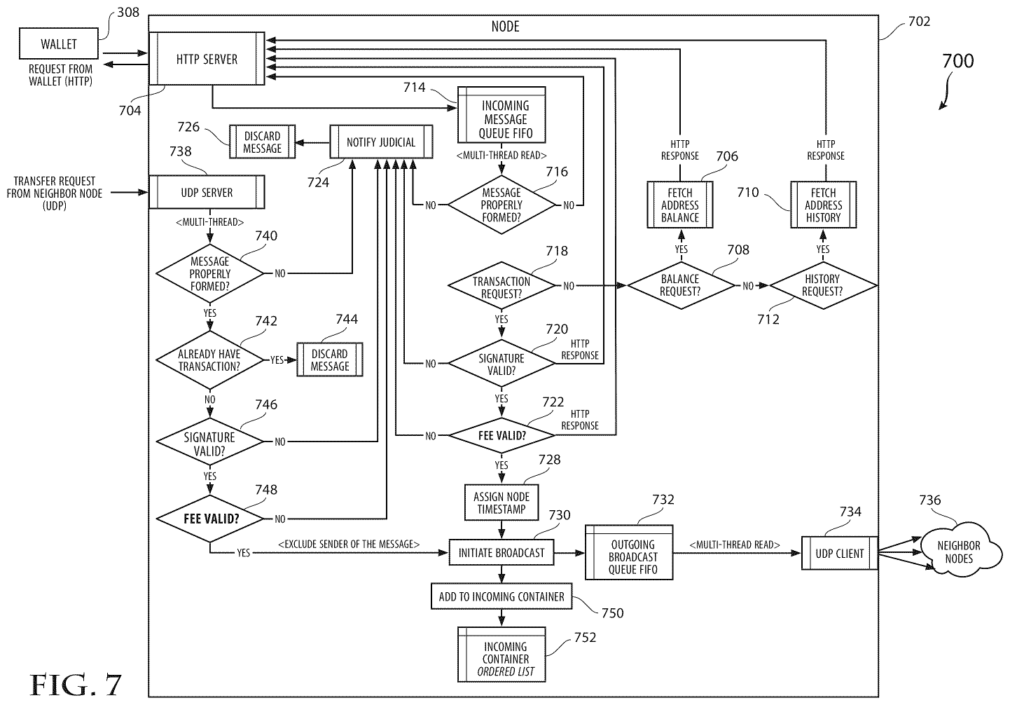

FIG. 7 illustrates a processing of node inputs 700 at each node 702. The node 702 can in one example receive two types of input. One input can be a request from a wallet 308 for a transaction which is processed in a certain way. Another type of input can be a transfer request from a neighbor node through UDP. The first type of input is addressed next. This process includes receive a request from a wallet 308 via HTTP (Hypertext Transfer Protocol) and at an HTTP server 702 operating on a node 702. The request is placed in an incoming message queue 714 which can be configured as a first-in-first-out (FIFO) queue on the node 702. The HTTP server 704 can be a separate node or server computing device in which case the request will just be forwarded on to a proper node of the network. The network can have one entry point such as an HTTP server 704 which can then forward the request to a particular node in the network based on one or more parameters. Once the one chosen node receives the request and then the processing occurs as disclosed herein.

Through a multi-thread read, the message is processed to determine whether it is properly formed 716. If no, then a notice is communicated to the HTTP server 704 and a notice is provided to the judicial component 724 which will discard the message 726. If the message is properly formed, a determination is made whether it is a transaction request 718. If no, then a balance request is determined 708. If the balance request is a yes, then the process includes fetching an address balance 706 and an HTTP response is provided to the HTTP server 704. If the balance request 708 is “no”, then the process involves seeking a history request 712 and if yes, the process fetches an address history 710 and provides an HTTP response to the HTTP server 704.

If the transaction request 718 resolves to a yes, then the system determines if there is a valid signature 720. If no, then the judicial component 724 is notified and the message is discarded 726. If no, an HTTP response is also provided to the HTTP server 704. Next, the system determines if the fee is valid in connection with the request 722. The fee data can be part of the message coming from the wallet 308 for a transaction to occur. The valid fee may be a required minimum to process the transaction but it could also include more than is required where a party wants to contribute to the blockchain network, and both types of fees would be considered valid. If the answer is “no” to the requestion of the fee being valid, then the judicial module 724 is notified and the message is discarded 726. An HTTP response is provided to the HTTP server 704. This is an up-front validation request that can reject this potential transaction up front before it gets placed into one of the containers for further broadcasting.

If yes, then the process assigns a timestamp to the request 728 and a broadcast process is initiated 730 in which the stamped request is added to an outgoing broadcast queue in a FIFO manner 732 and in a multi-thread read, the stamped message is provided to a UDP client 734 for broadcasting to the neighbors 736 of the current node 702. The stamped request is also added to an incoming container 750 and included in an ordered list of the incoming container 752.

The second type of input can be a transfer request from a neighbor via UPD which is received at a UDP server 738. Through a multi-thread read, the system determines if the message is properly formed 740 and if no, a notice is sent to the judicial module 724 and the message is discarded 726.

Protocols between the UDP servers (components that listen on a port for messages), nodes, what nodes messages can come from, how the message is configured, and so forth all play a part in whether a message is even received and not discarded at step 312. Further, a set of IP addresses can also be listed for what IP addresses messages are received from. Messages that do not meet any of these requirements can be discarded which can help protected against from hacking from unknown systems.

If the message check is a “yes” meaning that some or all these criteria are met, then the system determines if it already has the transaction 742. If yes, then the message is discarded 744. If no, then the system determines if the signature is valid for the message 746 and if no, via the judicial module 724, the message is discarded 726. If the signature is valid and the question of whether the fee is valid 748 is yes, then the message is initiated for broadcast 730 to the other neighbors, except the neighbor who sent the message to the node 702 and added to the outgoing broadcast queue in a FIFO manner 732. Again, the minimum valid fee for processing a transfer request from a neighbor is determined by the node to be proper in step 748. The message is also added to the incoming container 750 and placed in an ordered list 752 as part of the incoming container process. The neighboring nodes both with new transactions or transactions received from other nodes should perform the steps of verifying a valid signature of message and confirming that the fee is valid or at least a minimal fee amount is included. However, the node 702 will nevertheless confirm for itself through steps 720, 722, 746, 748 that the signature is valid and that the fee is valid for each message it receives.

Between messages being received at the HTTP server 704 and the UDP server 738, there are one or more types of requests or messages that can be processed. That can include transfer requests from neighbors, balance inquiries or a history inquiry. These come in through the HTTP-formatted message 704 for those kinds of messages. A balance inquiry or a history inquiry received at a node are not passed on to other nodes but the respective node just responds to the inquiry on its own. No consensus is required for these types of inquiries. For a transfer request, the system confirmed that the message is properly formed and signed in step 716 as noted above.

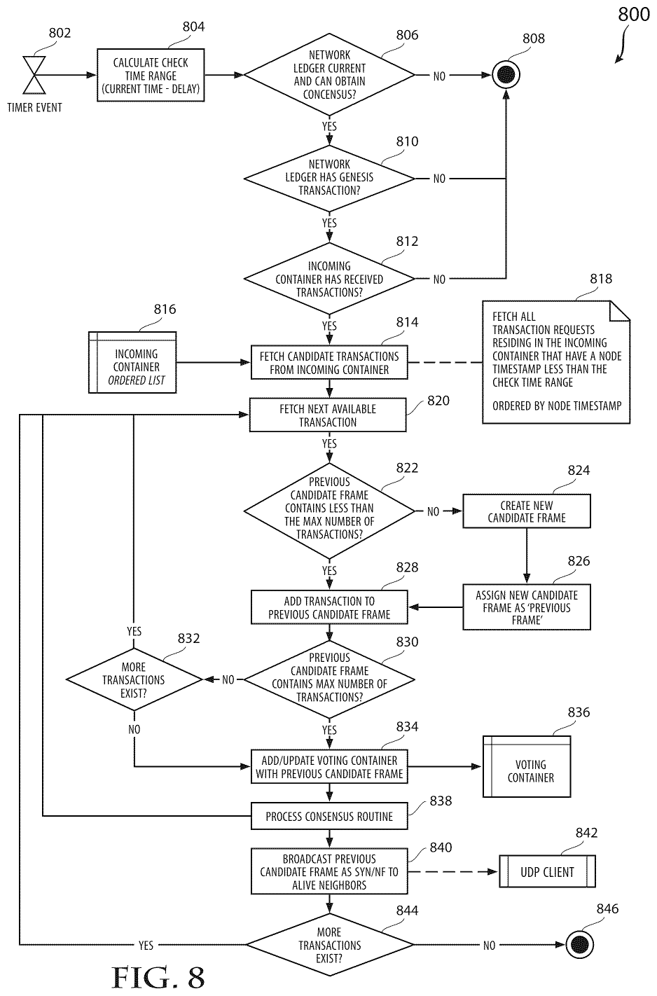

FIG. 8 illustrates the processing by an incoming container 800 operating at each node. The incoming container 800 can correspond to the incoming container 318 shown in FIG. 3. A timer event 802 (which can correspond to time delay 324) can cause or be associated with the initiation of the calculation to check a time range associated with a current time and the time delay 804 and then the system can determine whether the network ledger is current, and it obtain consensus 806. If no, then the process stops 808. If yes, then the system determines whether the network ledger has a genesis transaction 810 and if no, the process stops 808. If yes, then the system determines if the incoming container has received transactions 812. If no, the process stops 808 and if yes, then the system fetches candidate transactions from the incoming container 812. It fetches all transaction requests residing in the incoming container that have a node timestamp less than the check time range 818. The ordering of transactions can be done according to the node timestamp. The incoming container ordered list 816 is provided at this stage to the incoming container. For example, the incoming container 816 may receive verified unique transactions as well as verified unique transactions from one or more neighbor nodes and apply a unique identifier sorter that maintains on the node the order based on a unique ID and then broadcasts its order to the neighboring nodes. Next, the system fetches a next available transaction 820 and determines if the previous candidate frame contains less than the maximum number of transactions 822. If no, then the system creates a new candidate frame 824 and assigned the new candidate frame as a previous frame 826. If yes, then the system adds the transaction to the previous candidate frame 828. Next, the system determines whether the previous candidate frame contains a maximum number of transactions 830 if no, it determines whether more transactions exist 832. If yes, the process returns to step 820 to fetch the next available transaction. If no, then the process or system adds/updates a voting container 836 with the previous candidate frame 834. The voting container 836 can correspond to the voting container 346 in FIG. 3. The step of adding/updating the voting container 836 with the previous candidate frame 834 also occurs if the answer is “yes” to step 830 of whether the previous candidate frame contains a maximum number of transactions.

After adding/updating the voting container 836 with the previous candidate frame 834, the system processes or runs the consensus routine 838 and returns to the step of fetching the next available transaction 820. The system broadcasts the previous candidate frame as a syn/nf message to alive neighbors 840 via the UDP client 842 and determines if there are more transactions 844. If yes, then the process returns to the step of fetching the next available transaction 820 and if not, the process ends 846.

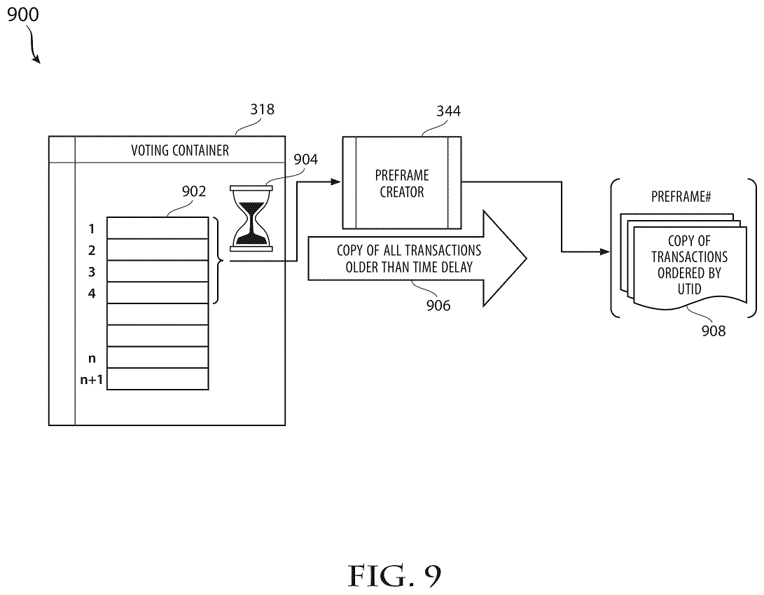

FIG. 9 illustrates the processing 900 by a preframe container 318 operating at each node. The incoming container 318 includes a uniquely ordered collection 902 of aged transactions that are packaged into preframes. For example, a group of transactions, based on a time delay 904, can include the selection of transactions 1, 2, 3 and 4 in FIG. 9. As transactions are received from neighbors and the transactions flow into the incoming container 318, they get laid out and sorted in the incoming container based on the timestamp or its unique transaction identifier (UTID).

The preframe creator or preframe container 344 will order the selected transactions. Each node broadcasts 906 and receives this bundle of transaction messages (preframes) via UDP packets. This process notifies all the neighbors of the existence of transactions to be considered for application to the ledger. The aged transactions are identified by the time frame 904 which can correspond to the time delay 324 of FIG. 3. The preframe container 344 will create a copy of the transactions 906 older than the time delay 904 and transmit them as preframes ordered by a unique transaction identifier (UTID) 908. The UTID can be unique across the entire network for the specific transaction. The initial transfer request from a wallet can be verified by the node 302 that receives the request which can be part of the process for establishing the UTID. The UTID can relate also to the time stamp 314 which may or may not include a time stamp specifically in that the ordering of the transactions 902 may not be a chronological ordering. The time stamp 314 or UTID may simply be a unique transaction identifier for a transaction and the ordering can be based on that identifier whether time is involved or not.

In one aspect, the system is not concerned with timing but seeks to accomplish a universal unique order across the entire network. The unique identification for each transaction is used as the order attribute. The desire is to establish a universal order within the network. The incoming container 318 maintains the transaction order based on all the transaction properties that make the transaction unique (UTID).

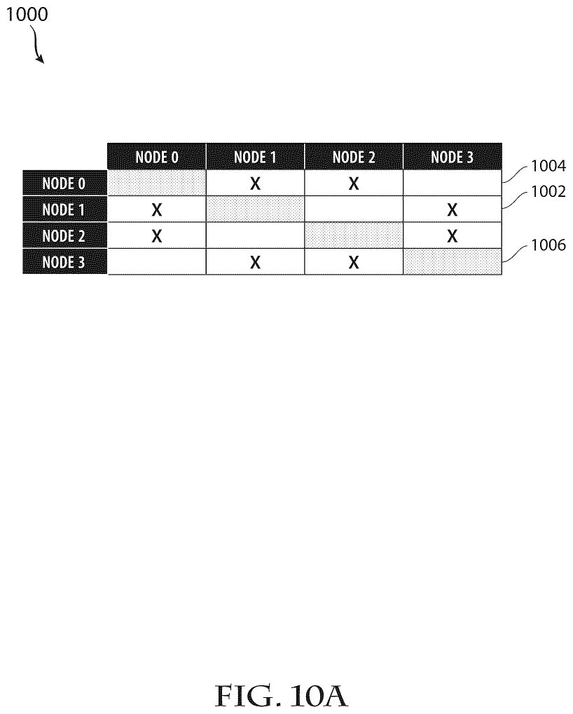

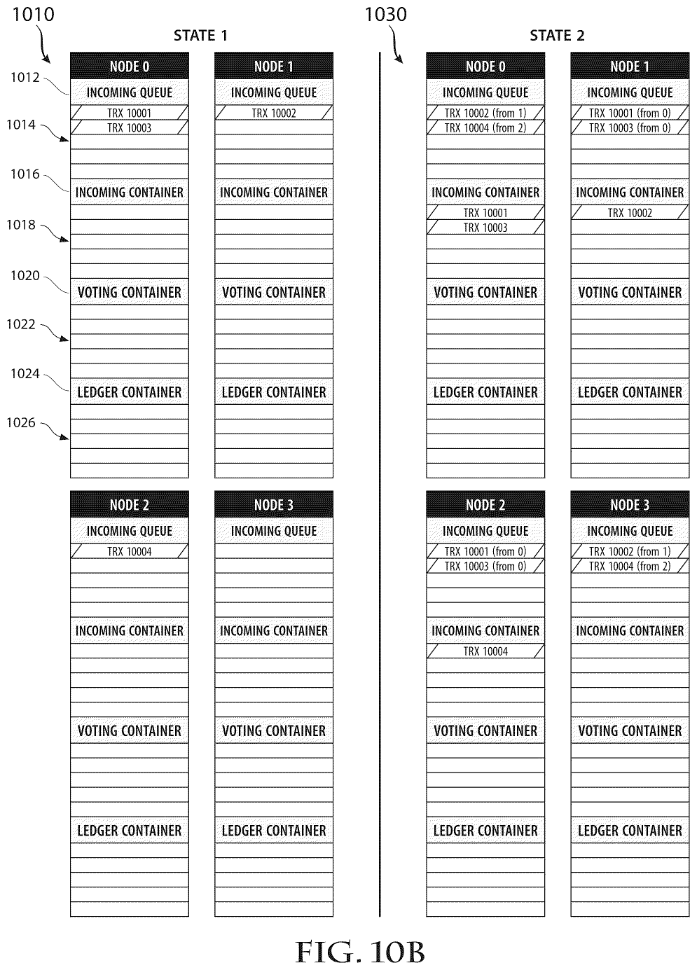

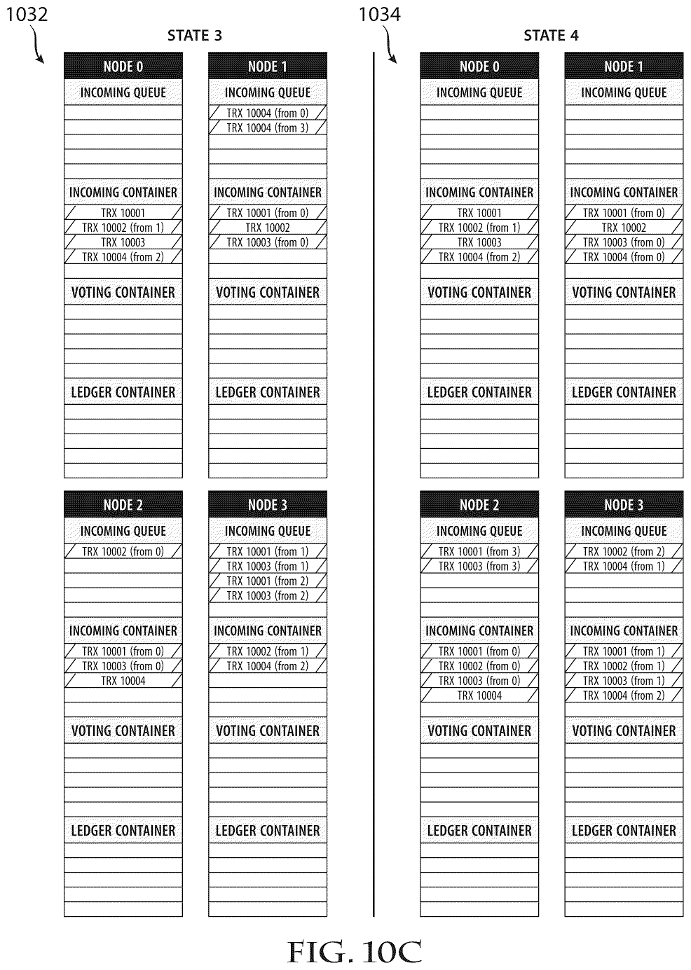

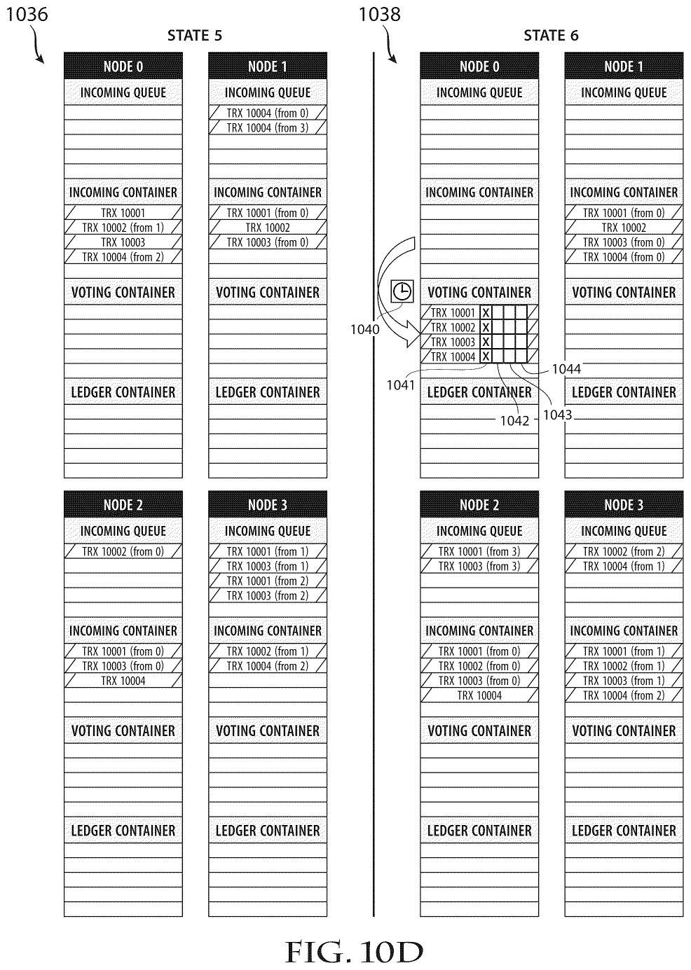

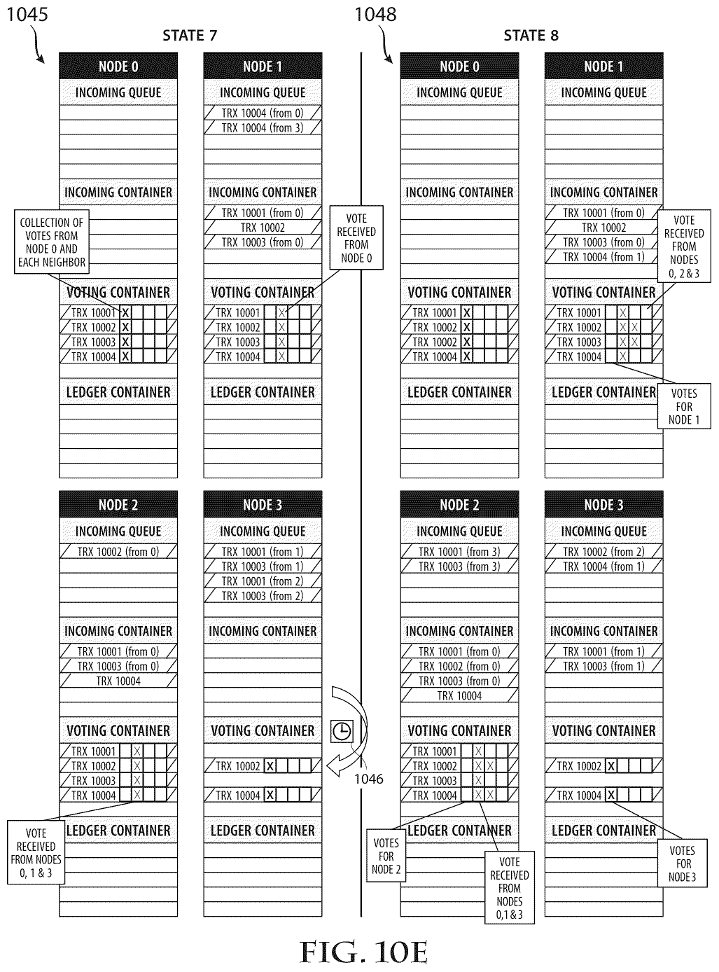

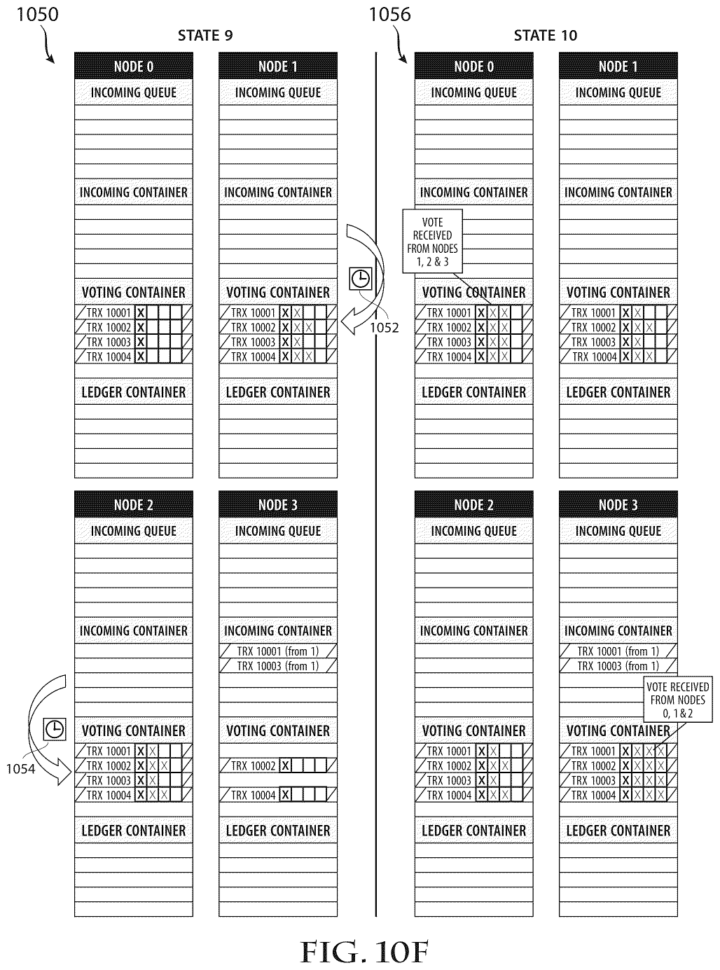

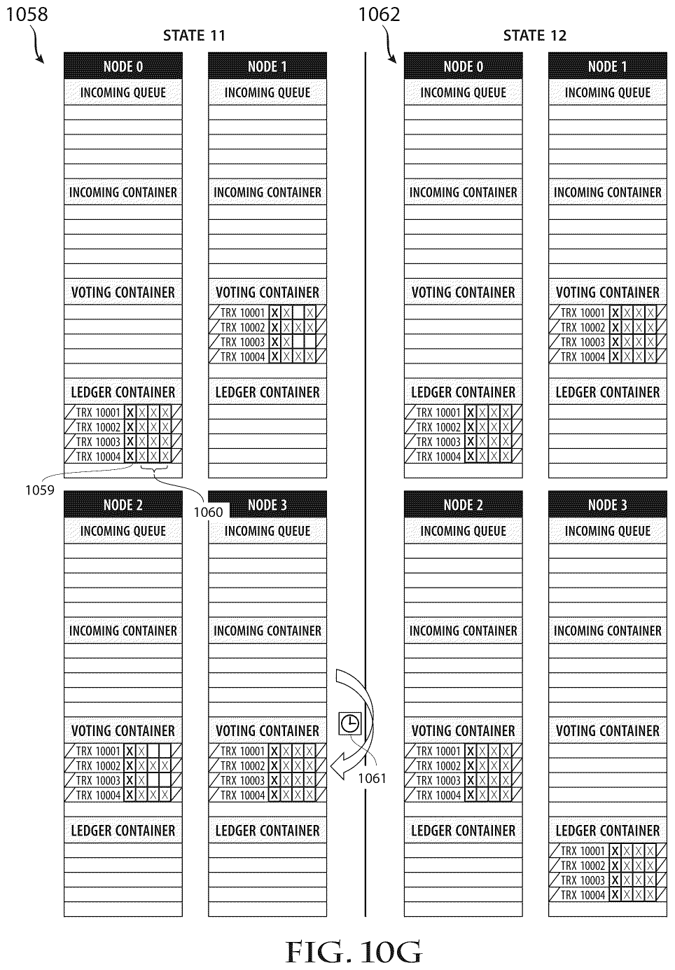

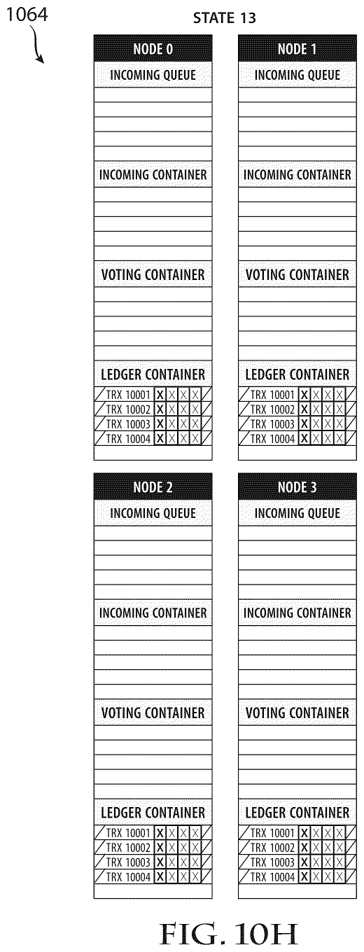

FIGS. 10A-10H illustrates the processing by the various data containers operating at each node. FIG. 10A illustrates a four-node matrix 1000 including nodes 0, 1, 2, and 3. This network 1000 includes four neighborhoods with neighborhoods including a first neighborhood of nodes 0-1-2, a second neighborhood consisting of nodes 0-1-3, a third neighborhood consisting of nodes 0-2-3 and a fourth neighborhood consisting of nodes 1-2-3. In one aspect, the consensus threshold can be set to 67% which can mean that at this setting, with the minimal network topology, each node collects successful votes from all neighbors to achieve this degree of consensus. For example, with a total of three participants in a neighborhood, more than two or three (ultimately all three) need to vote in agreement to achieve greater than a 67% threshold.

Field 1004 represents an empty field in which for example node 3 is not in the same neighborhood as node 0. Field 1002 includes an “X” indicating that node 3 is in a neighborhood with node 1. Field 1006 is also empty and shaded indicating no “X” can be placed in that field in that it represents the same node in the row and column of the matrix 1000.

Matrix 1000 represents, for example, that node 1 will transmit its messages to nodes 0 and node 3 based on the “X” in the proper fields of the matrix. The matrix 1000 indicates the following nodes will transmit messages to the respective nodes:
Node 0→Nodes 1, 2
Node 1→Nodes 0, 3
Node 2→Nodes 0, 3
Node 3→Nodes 1, 2

In the example state flow of FIGS. 10B-10H, this convention will be followed as, for example, Node 1 will transmit its messages to Nodes 0 and 3 only as part of its neighborhood.

FIGS. 10B-10H illustrate various states for nodes 0-4 with respect to processing messages from the various data containers. For example, in state 1 (feature 1010) in FIG. 10B, node 0 includes an incoming queue 1012, with data fields 1014 representing incoming messages. The incoming queue 1012 can be a First-in-First-out (FIFO) container holding all unprocessed messages respective by the network. The network can consist of all operating nodes 0-4. An incoming container 1016 can include data fields 1018 which will be filled with messages in the incoming container 1016. The incoming container 1016 can be a unique ID (UID) ordered container holding message that have been successfully validated and ready for processing. A voting container 1020 will receive messages in its input fields 1022. The voting container 1020 can be a complex container maintaining consensus vote collected on individual messages and their order to be proceed based on UID. A ledger container 1024 will receive messages into its input fields 1026. The ledger container 1024 can be a FIFO container holding messages to be applied to the immutable ledger. Each of the nodes 1, 2 and 3 include similar containers and input fields and the process of receiving messages, exchanging messages, voting on messages and recording on the ledger the proper transactions will be described next.

FIG. 10B illustrates the four nodes 1010 in a state 1 in which node 0 has received two transactions (transfer messages) TRX 10001, TRX 10003 in storage locations 1014 in its incoming queue 1012. The transfer message must pass signature and fee validation checks to move from the incoming queue 1012 to the incoming container 1016 for processing. One receipt of a properly signed transfer, the receiving node immediately generates the UID and publishes the transfer with the UID to its neighbors and places the transfer into the incoming container 1016. FIGS. 10B-10H will illustrate 13 different states of the processing of four transfers or transactions received by the network.

In state 1, node 1 has received TRX 10002 in storage locations in its incoming queue. Node 2 has received TRX 1004 in storage locations in its incoming queue. The transfer messages must pass signature and fee validation checks to move from the respective incoming queue to the incoming container for processing. Upon receipt of a properly signed transfer message, the receiving node immediately generates the unique ID (UID) and publishes the transfer with the UID to its neighbor nodes and places the transfer into the incoming container.

FIG. 10B also illustrates generally an incoming container 1016 with storage locations 1018, a voting container 1020 with storage locations 1022 and a ledger container 1024 with storage locations 1026. The incoming queue 1012, incoming container 1016, voting container 1020 and ledger container 1024 are included in each of the nodes 1, 2, 3 and 4 and can correspond respectively to the incoming message queue 310, incoming container 318, voting container 346 and ledger 372 of FIG. 3.

The four nodes 1030 in state 2 of FIG. 10B represent the state of the system after the nodes publish their transfer messages and the messages are received at the respective nodes. The transfer message received by neighbors must pass signature and fee validation checks to move from the incoming queue to the incoming container for processing. Upon receipt from a neighbor of a properly signed transfer that the receiving node is not already aware of, the receiving node re-publishes the transfer to its neighbors, excluding the neighbor that originally sent the message, and places the transfer into the incoming container. If the receiving node has already been made aware of the specific transfer, the node discards the message.

In state 2, the incoming queue of node 0 includes TRX 10002 from node 1, and TRX 10004 from node 2. The incoming container of node 0 includes TRX 10001 and TRX 10003. The incoming queue of node 1 includes TRX 10001 from node 0 and TRX 10003 from node 0. The incoming container of node 1 includes TRX 10002. Also in state 2, the incoming queue of node 2 includes TRX 10001 from node 0 and TRX 10003 from node 0. The incoming container of node 2 includes TRX 10004. In state 2, node 3 includes TRX 10002 from node 1 and TRX 10004 from node 2 in its incoming queue. These transmissions are consistent with the matrix shown in FIG. 10A.

FIG. 10C illustrates the four nodes 0, 1, 2, 3 (feature 1032) in state 3. The process continues as any message is received into the incoming queue for processing. In this state, node 0 includes in its incoming container TRX 10001, TRX 10002 from node 1, TRX 10003 and TRX 10004 from node 2. Node 1 in state 3 includes in its incoming queue TRX 10004 from node 0 and TRX 10004 from node 3. The incoming container of node 1 includes TRX 10001 from node 0, TRX 10002 and TRX 10003 from node 0. Node 2 includes TRX 10002 in its incoming queue from node 0 and its incoming container includes TRX 10001 from node 0, TRX 10003 from node 0 and TRX 10004. Node 3 in state 3 has an incoming queue that contains TRX 10001 from node 1, TRX 10003 from node 1, TRX 10001 from node 2 and TRX 10003 from node 2. Its incoming container includes TRX 10002 from node 1 and TRX 10004 form node 2.

The four nodes 0, 1, 2, 3 (feature 1034) in state 4 includes the following status. In this stage, the process continues as any message is received into the incoming queue for processing. Node 0 has in state 4 in its incoming container TRX 10001, TRX 10002 from node 1, TRX 10003 and TRX 10004 from node 2. The incoming container of node 1 includes TRX 10001 from node 0, TRX 10002, TRX 10003 from node 0 and TRX 10004 from node 0. Node 2 in state 4 includes in its incoming queue TRX 10001 from node 3 and TRX 10003 from node 3. The incoming container in node 2 includes TRX 10001 from node 0, TRX 10002 from node 0, TRX 10003 from node 0 and TRX 10004. Node 3 in state 4 includes in its incoming queue TRX 10002 from node 2, TRX 10004 from node 1. The incoming container in node 3 in state 4 includes TRX 10001 from node 1, TRX 10002 from node 1, TRX 10003 from node 1 and TRX 10004 from node 2.

FIG. 10D illustrates the four nodes 0, 1, 2, 3 (feature 1036) in state 5 in which node 0 includes in its incoming container TRX 10001, TRX 10002 from node 1, TRX 10003 and TRX 10004 from node 2. Each node independently processes eligible messages from the incoming container by selecting all messages older that a global configuration time delay such as two seconds for example. The respective node each submits the messages (which include the order of transactions which they are to vote on) to their neighbors for a vote. For example, the neighbors are voting on an order of the transactions. In this example, node 0 initiated processing while the remaining nodes on the network are in state 5. Node 1 in state 5 includes in its incoming queue TRX 10004 from node 0 and TRX 10004 from node 3. The incoming container of node 1 includes TRX 10001 from node 0, TRX 10002 and TRX 10003 from node 0. The incoming queue of node 2 includes TRX 10002 from node 0. The incoming container of node 2 includes TRX 10001 from node 0, TRX 10003 from node 0 and TRX 10004. Node 3 in state 5 includes in its incoming queue TRX 10001 from node 1, TRX 10003 from node 1, TRX 10001 from node 2 and TRX 10003 from node 2. The incoming container of node 3 in state 5 includes TRX 10002 from node 1 and TRX 10004 from node 2.

The four nodes 0, 1, 2, 3 (feature 1038) in state 6 includes in node 0 the transfer of TRX 10001, TRX 10002, TRX 10003 and TRX 10004 after a period of time 1040 from the incoming container (see state 5 of node 0) to the voting container with a confirmation of the votes 1041 of the transactions from node 0. The “x” markings represent votes with the first column being the respective nodes own vote and each additional column 1042, 1043 representing a neighbor's vote. The table demonstrates how a node may collect votes from neighbors before it is eligible to vote itself. Columns 1042 and 1043 can represent a group of columns that depends on how many neighboring nodes are participating in the consensus algorithm. Two columns are shown but the number of columns to store or represent neighbor votes can vary. The node places the eligible requests into its own voting container and submits its own vote on the validity and order of each of the requests (denoted by X) and distributed to its neighbors for their votes. In state 6, node 1 includes in its incoming container TRX 10001 from node 0, TRX 10002, TRX 10003 from node 0 and TRX 10004 from node 0. In state 6, node 2 includes in its incoming queue TRX 10001 from node 3, TRX 10003 from node 3. Node 2 includes in its incoming container TRX 10001 from node 0, TRX 10002 from node 0, TRX 10003 from node 0 and TRX 10004. Node 3 in state 6 includes in its incoming queue TRX 10002 from node 2 and TRX 10004 from node 1. The incoming container of node 3 in state 6 includes TRX 10001 from node 1, TRX 10002 from node 1, TRX 10003 from node 1 and TRX 10004 from node 2.

FIG. 10E illustrates the four nodes 0, 1, 2, 3 (feature 1045) in state 7. When a node receives requests for vote from a neighbor, it checks to see if it has already started the voting process on the request. If not, it places the request into the voting container and marks the node that sent the request as voting in favor of the placement of the request. For this example, at the same time this process is taking place, the processing cycle on node 3 in FIG. 10E is initiated to be processing the incoming container requests. Node 0 includes in its voting container TRX 10001, TRX 10002, TRX 10003, TRX 10004 with a collection of votes from node 0 and each neighbor. The “x” markings represent votes with the first column being the respective node's own vote and each additional column representing a neighbor's vote. The figure shows how a node may collect votes from neighbors before it is eligible to vote itself. On receipt of votes 908 from a neighbor, a respective node immediately determines whether consensus is reached. The columns shown in FIG. 10E of neighbors represents steps of tallying the votes from neighbors. In one example with the 4 nodes, a 67% threshold can be set such that consensus is achieved once all the neighbors agree. Node 1 in state 7 includes in its incoming queue TRX 10004 from node 0 and TRX 10004 from node 3. The incoming container of node 1 in state 7 includes TRX 10001 from node 0, TRX 10002 and TRX 10003 from node 0. The voting container of node 1 in state 7 includes TRX 10001, TRX 10002, TRX 10003 and TRX 10004 with votes received from node 0 and each neighbor. Node 2 in state 7 includes in its incoming queue TRX 10002 from node 0. The incoming container of node 2 includes TRX 10001 from node 0, TRX 10003 from node 0 and TRX 10004. The voting container of node 2 in state 7 includes TRX 10001, TRX 10002, TRX 10003, and TRX 10004 with votes received from node 0. Node 3 in state 7 includes in its incoming queue TRX 10001 from node 1, TRX 10003 from node 1, TRX 10001 from node 2 and TRX 10003 from node 2. Node 3 in state 7 will wait a period of time 1046 before transferring transactions in its incoming container to the voting container. Shown in the voting container of node 3 are TRX 10002 and TRX 10004 with votes in the first column indicating votes of node 3 for these transactions and the order of the transactions. Note that FIG. 10E went briefly ‘back in time’ as the incoming queue is still holding those at the time their processing timer kicked off. The figure shows how the timers are not necessarily synchronized and can run at any time independent of neighbor nodes.

When transactions from an incoming neighbor's pre-frames plus one local pre-frame gets inserted into a sorted voting container on a node, the same transaction take the same slot in the voting container, effectively increasing an associated counter. Voting for a specific transaction succeeds the moment the counter become bigger than a defined benchmark, such as 50% of neighbors.

In FIG. 10E, the status in state went briefly ‘back in time’ as the incoming queue is still holding transactions at the time their processing timer 1046 was initiated. This illustrates how the timers 1046 across nodes are not necessarily synchronized and can run at any time on a respective node independent of its neighbor nodes.

FIG. 10E shows nodes 0, 1, 2, 3 (feature 1048) in state 8. A node will not provide its vote on a request until it successfully votes on it itself. If a node is not yet aware of a specific request that all of its neighbors have voted in consensus, additional messaging requests are made to its neighbors to obtain the unknown request. The node continues to collect submitted votes while this reconciliation process completes such that it can determine valid consensus as soon as it is prepared to vote on the specific request. Node 0 in state 8 includes TRX 10001, TRX 10002, TRX 10003, TRX 10004 in its voting container with the collection of votes from node 0 and each neighbor. Node 1 in state 8 includes TRX 10001 from node 0, TRX 10002, TRX 10003 from node 0, TRX 10004 from node 1. The voting container of node 1 in state 8 includes TRX 10001, TRX 10002, TRX 10003 and TRX 10004 with votes received from nodes 0 and 3. Node 2 in state 8 includes in its incoming queue TRX 10001 from node 3, TRX 10003 from node 3. The incoming container of node 2 in state 8 includes TRX 10001 from node 0, TRX 10002 from node 0, TRX 10003 from node 0 and TRX 10004. The voting container of node 2 in state 8 includes TRX 10001, TRX 10002, TRX 10003, TRX 10004 with votes received from nodes 0 and 3. Node 3 in state 8 includes in its incoming queue TRX 10002 from node 2, TRX 10004 from node 1. The incoming container of node 3 in state 8 includes TRX 10001 from node 1 and TRX 10003 from node 1. The voting container of node 3 in state 8 includes TRX 10002 and TRX 10004 with votes as shown from itself in the first column. Other columns for votes from additional nodes can be included as well.

FIG. 10F shows the four nodes 0, 1, 2, 3 (feature 1050) in state 9 in which node 0 includes in its voting container TRX 10001, TRX 10002, TRX 10003, TRX 10004 with votes collected from node 0 and each neighbor. The processing cycles are executed on nodes 1 and 3 to processing the requests pending in their incoming containers. The processing generates the vote for the individual node and communicates the vote to the node's neighbors. Node 1 in state 9 transfers TRX 10001, TRX 10002, TRX 10003, TRX 10004 from its incoming container to its voting container after a period of time 1052 and includes its votes for the validity of the transactions and the order of transactions. Node 2 in state 9 includes TRX 10001, TRX 10002, TRX 10003, TRX 10004 transferred from the incoming container to the voting container after a predetermined period of time 1054. The votes for these transactions are shown. Node 3 in state 9 includes the incoming container including TRX 10001 and TRX 10003 both from node 1. The voting container of node 3 includes TRX 10002 and TRX 10004 with its votes. A node only votes itself when it processes transactions from its incoming container into the voting container but prior to this (because of timing) the node could receive votes from its neighbors on transactional order. However, until it is able to vote itself, those neighbor votes are just held within the voting container. This condition is shown in state 8 in which node 2 has a voting container with that has received votes from nodes 0 and 3 but has not yet voted itself since the first column of the voting container is empty.

FIG. 10F also includes the four nodes 0, 1, 2, 3 (feature 1056) shown in state 10. Node 0 includes TRX 10001, TRX 10002, TRX 10003, TRX 10004 with votes received from nodes 1 and 2 shown. Node 1 in state 10 includes TRX 10001, TRX 10002, TRX 10003, TRX 10004 with votes for these transactions. Node 2 includes TRX 10001, TRX 10002, TRX 10003, TRX 10004 with votes for these transactions. Node 3 includes in its incoming container TRX 10001 from node 1 and TRX 10003 from node 1. The voting container includes TRX 10001, TRX 10002, TRX 10003, TRX 10004 with votes received from nodes 1 and 2.

FIG. 10G illustrates the four nodes 0, 1, 2, 3 (feature 1058) in state 11 with the ledger container of node 0 including TRX 10001, TRX 10002, TRX 10003, TRX 10004 with its completed votes and ready for recording on the ledger. Column 1059 represents the votes from the respective node 2 and a group of columns 1060 represent the votes from one or more other nodes. The number of columns in the group of columns 1060 will vary depending on how many other neighbor nodes are participating. The processing cycles are executed on node 3 to process the requests pending in the incoming container. The processing generates the vote for the individual node and communicates their vote to their neighbors. Node 1 in state 11 includes TRX 10001, TRX 10002, TRX 10003, TRX 10004 in the voting container with the voting in process. Node 1 includes TRX 10001, TRX 10002, TRX 10003, TRX 10004 in its voting container with voting in process. Node 3 shows a transfer of TRX 10001, TRX 10002, TRX 10003, TRX 10004 from the incoming container to the voting container after a period of time 1061.

FIG. 10G also illustrates the four nodes 0, 1, 2, 3 (feature 1062) in state 12 including node 0 having TRX 10001, TRX 10002, TRX 10003, TRX 10004 in its ledger container. Upon receipt of a vote, the node calculates consensus on the collected votes as long as the node has itself voted on the placement of the request. When a node processes transactions from its incoming container into the voting container, it submits its own vote which is represented in the first column of the figures. Typically, when a node processes transactions from its incoming container into its voting container, the node submits its own vote at that time. If the node has itself voted, the request is moved to the ledger container to be applied to the immutable ledger. The node will node advance to the next request in the voting container until the first request in the container achieves consensus. Node 1 in state 12 includes in its voting container TRX 10001, TRX 10002, TRX 10003, TRX 10004. Node 2 includes TRX 10001, TRX 10002, TRX 10003, TRX 10004 in its voting container in state 12. Node 3 includes TRX 10001, TRX 10002, TRX 10003, TRX 10004 in its ledger container.

FIG. 10H shows the last state 13 in the process. Having all votes received, all the nodes achieve the same state with all requests in the ledger container to be persisted. Nodes 0, 1, 2, 3 (feature 1064) are in state 13 in which node 0 includes TRX 10001, TRX 10002, TRX 10003, TRX 10004 in its ledger container, node 1 includes TRX 10001, TRX 10002, TRX 10003, TRX 10004 in its ledger container. Node 2 includes TRX 10001, TRX 10002, TRX 10003, TRX 10004 in its ledger container and node 3 includes TRX 10001, TRX 10002, TRX 10003, TRX 10004 in its ledger container. All the voting can be completed as shown in the respective node voting columns for each respective ledger container.

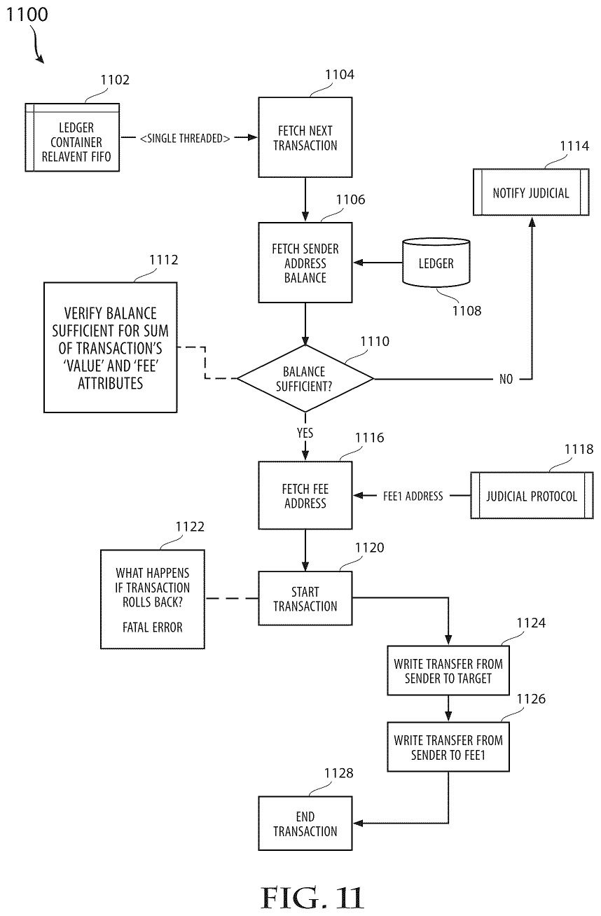

FIG. 11 illustrates the processing 1100 by a ledger commitment component such as the ledger 372 shown in FIG. 3 and operating at each node. These are processes that occur just prior to a transaction is applied to its ledger. Each node independently does these same processes to apply transactions to their ledger. All the transactions in a particular order, in a frame, are proper. The ledger container 1102 (or ledger 372) through a single thread communication causes the system to fetch a next transaction 1104. The system fetches a sender address balance 1106 and retrieves data from the ledger 1108. The system asks whether the balance is sufficient 1110 which can include verifying whether the balance is sufficient for a sum of transaction's values and fee attributes 1112. If no, then the judicial module is notified 1114 and the transaction is in one aspect dropped. If yes, then the system fetches a fee address 1116 (where it goes to get the fee paid) and typically receives the fee address from the judicial module 1118. The judicial layer 1118 provides the recipient address of the fees. This is typically an organization or foundational fee that the system managing the overall blockchain network needs. Since each node is operating independently, a process would have to occur across all nodes that at a very specific point in time they would have to change the target fee address. In one aspect, the network can allow for the ‘change fee address’ request to be received by the network as a transaction which is processed as other transactions requiring consensus and processed in the same sequential order between the nodes. Any one node that misses the change, and sends the fees to a different address, then there is an inconsistency that would occur. Thus, the judicial layer will have the target fee address that is queried prior to starting the transaction 1120. The balance sufficient 1110 question is whether the sender address is sufficient, meaning that the value that you want to send from this sender address to a recipient address plus any fees associated to that transaction. Those two amounts are the “balance” needed in the sender address. The sender address pays the fees for this transaction.

In one aspect, a voting mechanism can occur amongst the nodes in the blockchain network to simultaneously suspend transactions, and not apply anything to the ledger, and then make a change to the target fee address. In this manner, the system can change who gets paid for processing transactions from an institutional standpoint. As noted above, the operation to simultaneously suspend transactions and optionally take other actions such as making a change to the target fee address can be received by the network as a transaction which is processed as other transactions or with other transactions requiring consensus and thus processed in the same sequential order between the nodes.

Next, the system starts the transaction 1120. If the transaction rolls back, then there is a fatal error 1122. Transaction is a way to start multiple database activities into one unit of work. If something fails in the middle of the series of activities. For example, if there is a hardware failure like a memory glitch or hard-drive fails, if the transaction fails and the transaction rolls back its going to indicate a fatal error and a recovery mechanism is initiated. When the transaction starts, the system writes a transfer from the sender to a target fee address 1124 and writes a transfer from the sender to the fee address 1126 and ends the transaction 1128 which indicates that it writes the transaction to the ledger and the fees are properly paid.

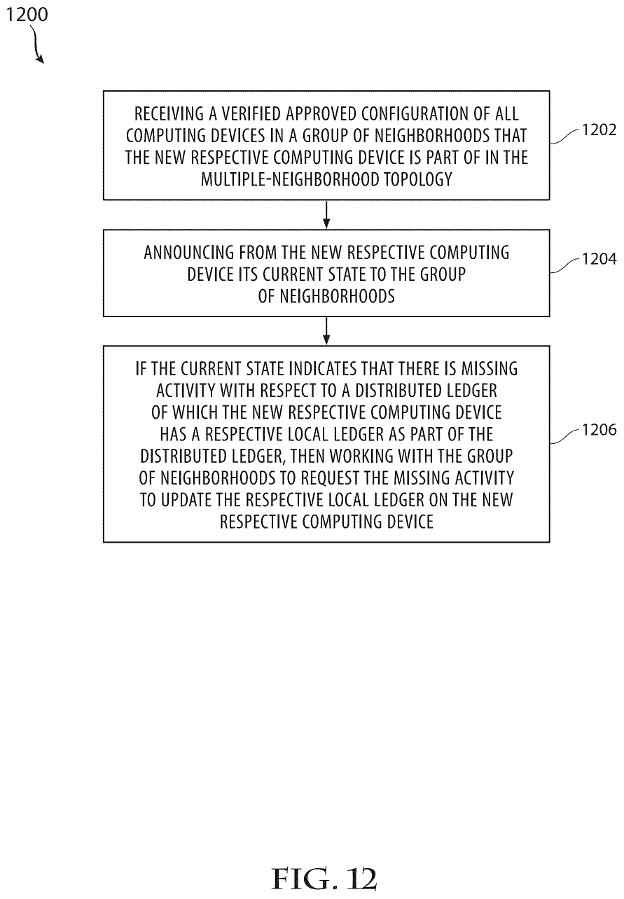

FIG. 12 illustrates an example method 1200 related to operating a blockchain network. The method 1200 can operate in the context of connecting a new respective computing device to a set of networked computing devices configured in a multiple-neighborhood topology. The method 1200 can relate to the node start-up and synchronization process of FIG. 6B. The method 1200 can included one or more of receiving a verified approved configuration of all computing devices in a group of neighborhoods that the new respective computing device is part of in the multiple-neighborhood topology (1202), announcing, from the new respective computing device, a current state to the group of neighborhoods (1204), if the current state indicates that there is missing activity with respect to a distributed ledger of which the new respective computing device has a respective local ledger as part of the distributed ledger, then working with the group of neighborhoods to request the missing activity to update the respective local ledger on the new respective computing device (1206). Previously unknown transactions received during a synchronization process should successfully reach consensus to be accepted.

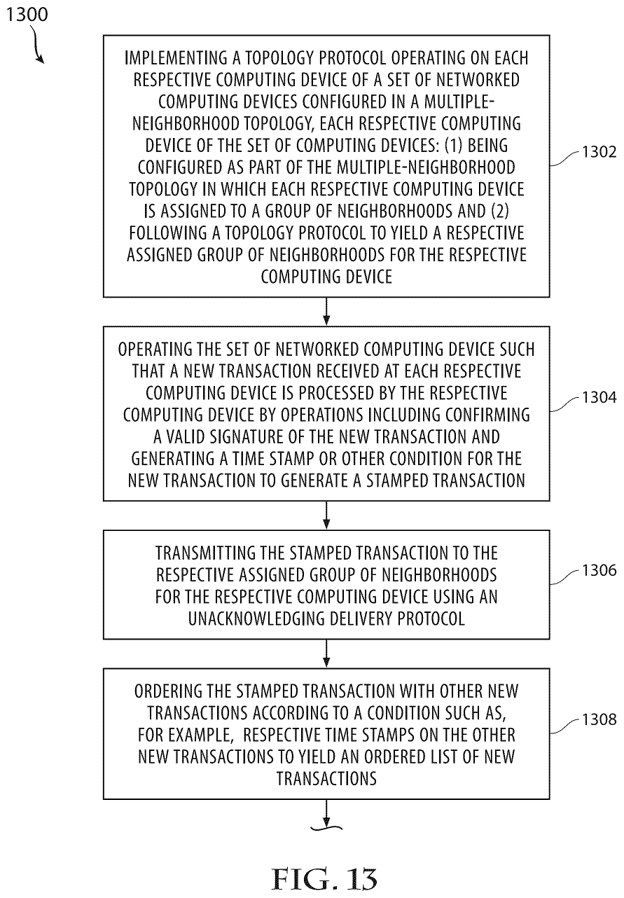

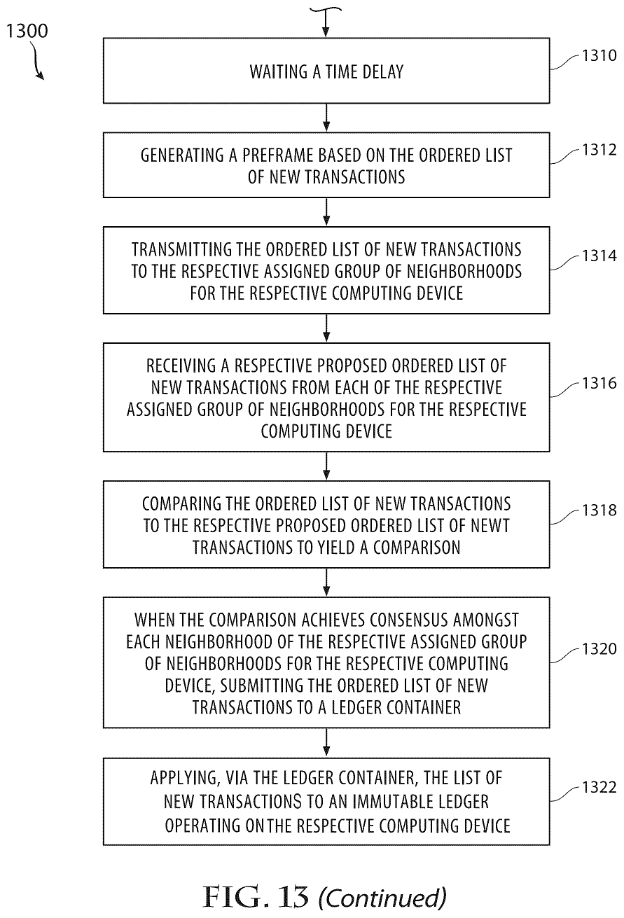

FIG. 13 illustrates an example method 1300 related to operating the blockchain network in the manner disclosed herein. The method 1300 can include one or more of implementing a topology protocol operating on each respective computing device of a set of networked computing devices configured in a multiple-neighborhood topology, each respective computing device of the set of networked computing devices: (1) being configured as part of the multiple-neighborhood topology in which each respective computing device is assigned to a group of neighborhoods and (2) following a topology protocol to yield a respective assigned group of neighborhoods for the respective computing device (1302). Each respective neighborhood of the group of neighborhoods can include a different subset of the set of networked computing devices in which the different subset of the set of networked computing devices only communicates with other computing devices in its respective assigned group of neighborhoods. The method can further include operating the set of networked computing device such that a new transaction received at each respective computing device is processed by the respective computing device by operations including confirming a valid signature of the new transaction and generating a time stamp or other condition, for the new transaction to generate a stamped transaction (1304), transmitting the stamped transaction to the respective assigned group of neighborhoods for the respective computing device using an unacknowledging delivery protocol (1306), ordering the stamped transaction with other new transactions according to a condition such as, for example, respective time stamps on the other new transactions to yield an ordered list of new transactions (1308), waiting a time delay (1310), generating a preframe based on the ordered list of new transactions (which can also be older than a time delay) (1312), transmitting the ordered list of new transactions to the respective assigned group of neighborhoods for the respective computing device (1314), receiving a respective proposed ordered list of new transactions from each of the respective assigned group of neighborhoods for the respective computing device (1316), comparing the ordered list of new transactions to the respective proposed ordered list of new transactions to yield a comparison (1318), when the comparison achieves consensus amongst each neighborhood of the respective assigned group of neighborhoods for the respective computing device, submitting the ordered list of new transactions to a ledger container (1320) and applying, via the ledger container, the list of new transactions to an immutable ledger operating on the respective computing device (1322).

The conditions referenced above may be non-time-based and may be associated with a network condition, network status, a characteristic of new or old transactions, a characteristic of a group of transactions, a latency, a location of one or more neighbor nodes, a characteristic of a group of nodes, and so forth.

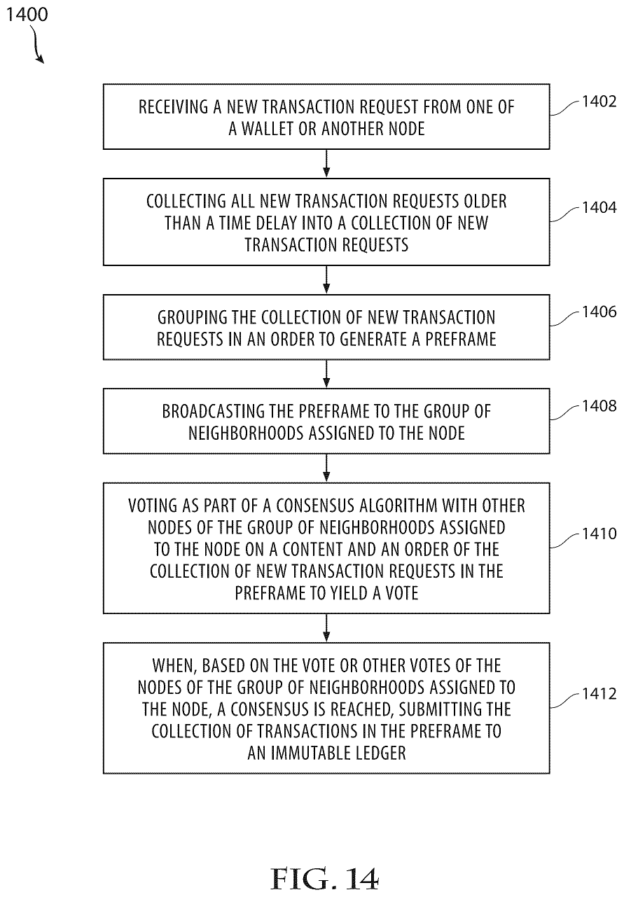

In another example, FIG. 14 illustrates a method 1400 related to managing a transaction lifecycle on a node of a blockchain network having a topology protocol operating on each respective node of a set of networked nodes configured in a multiple-neighborhood topology. Each respective node of the set of networked nodes: (1) being configured as part of the multiple-neighborhood topology in which each respective node is assigned to a group of neighborhoods and (2) following a topology protocol to yield a respective assigned group of neighborhoods for the respective node, wherein each respective neighborhood of the group of neighborhoods comprises a different subset of the set of networked nodes in which the different subset of the set of network nodes only communicates with other nodes in its respective assigned group of neighborhoods.

The example method 1400 includes one or more steps including receiving a new transaction request from one of a wallet or another node (1402), collecting all new transaction requests older than a time delay into a collection of new transaction requests (1404), grouping the collection of new transaction requests in an order to generate a preframe (1406), broadcasting the preframe to the group of neighborhoods assigned to the node (1408), voting as part of a consensus algorithm with other nodes of the group of neighborhoods assigned to the node on a content and an order of the collection of new transaction requests in the preframe to yield a vote (1410), when, based on the vote or other votes of the nodes of the group of neighborhoods assigned to the node, a consensus is reached, submitting the collection of transactions in the preframe to an immutable ledger (1412).

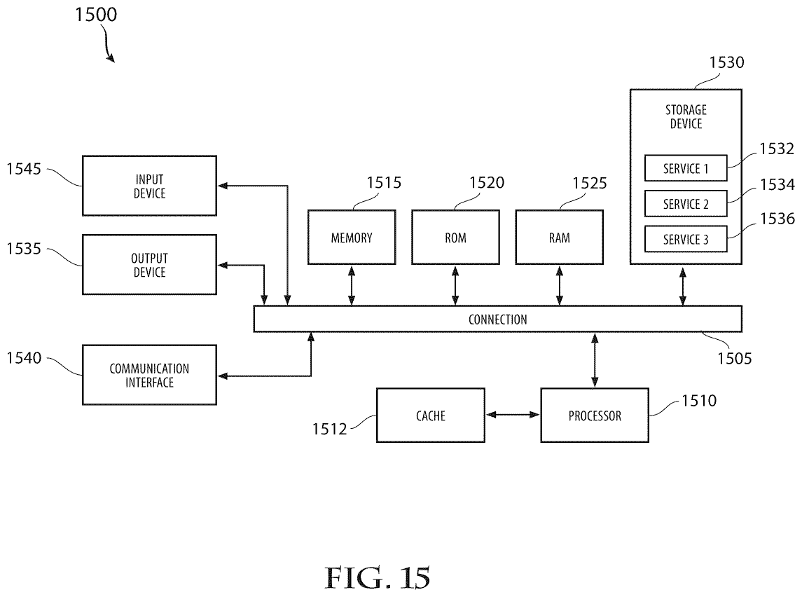

FIG. 15 illustrates a computing system architecture 1500 including various components in electrical communication with each other using a connection 1506, such as a bus. Example system architecture 1500 includes a processing unit (CPU or processor) 1504 and a system connection 1506 that couples various system components including the system memory 1520, such as read only memory (ROM) 1518 and random access memory (RAM) 1516, to the processor 1504. The system architecture 1500 can include a cache 1502 of high-speed memory connected directly with, in close proximity to, or integrated as part of the processor 1504. The system architecture 1500 can copy data from the memory 1520 and/or the storage device 1508 to the cache 1502 for quick access by the processor 1504. In this way, the cache can provide a performance boost that avoids processor 1504 delays while waiting for data. These and other modules can control or be configured to control the processor 1504 to perform various actions.

Other system memory 1520 may be available for use as well. The memory 1520 can include multiple different types of memory with different performance characteristics. The processor 1504 can include any general purpose processor and a hardware or software service, such as service 1 1510, service 2 1512, and service 3 1514 stored in storage device 1508, configured to control the processor 1504 as well as a special-purpose processor where software instructions are incorporated into the actual processor design. The processor 1504 may be a completely self-contained computing system, containing multiple cores or processors, a bus, memory controller, cache, etc. A multi-core processor may be symmetric or asymmetric.

To enable user interaction with the computing system architecture 1500, an input device 1522 can represent any number of input mechanisms, such as a microphone for speech, a touch-sensitive screen for gesture or graphical input, keyboard, mouse, motion input, speech and so forth. An output device 1524 can also be one or more of a number of output mechanisms known to those of skill in the art. In some instances, multimodal systems can enable a user to provide multiple types of input to communicate with the computing system architecture 1500. The communications interface 1526 can generally govern and manage the user input and system output. There is no restriction on operating on any particular hardware arrangement and therefore the basic features here may easily be substituted for improved hardware or firmware arrangements as they are developed.

Storage device 1508 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1516, read only memory (ROM) 1518, and hybrids thereof.

The storage device 1508 can include services 1510, 1512, 1514 for controlling the processor 1504. Other hardware or software modules are contemplated. The storage device 1508 can be connected to the system connection 1506. In one aspect, a hardware module that performs a particular function can include the software component stored in a computer-readable medium in connection with the necessary hardware components, such as the processor 1504, connection 1506, output device 1524, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

Claim clauses of this application include:

Clause 1. A system, comprising: a set of networked computing devices configured in a multiple-neighborhood topology, each respective computing device of the set of networked computing devices being configured as part of the multiple-neighborhood topology in which each respective computing device is assigned to a group of neighborhoods and follows a topology protocol to yield a respective assigned group of neighborhoods for the respective computing device, wherein each respective neighborhood of the group of neighborhoods comprises a different subset of the set of networked computing devices in which the different subset of the set of networked computing devices only communicates with other computing devices in its respective assigned group of neighborhoods; a respective ledger operating on each respective computing device for recording transactions, wherein a combination of each respective ledger on each respective computing device comprises a distributed ledger; a respective consensus algorithm running on each respective computing device such that when a respective transaction of a group of transactions is to be made via application of the respective consensus algorithm, a set of rules according to a transaction protocol applies in order for the respective transaction to be recorded on the distributed ledger, wherein the transaction protocol comprises a combination each operation of each respective consensus algorithm on each respective computing device and further comprises: receiving, at a first computing device in a first neighborhood, the respective transaction to be recorded on the distributed ledger across the set of networked computing devices; communicating the respective transaction to each neighbor of the first computing device, wherein each neighbor of the first computing device comprises the respective assigned group of neighborhoods for the first computing device; continuing to communicate the respective transaction from neighborhood to neighborhood in the set of networked computing devices according to the multiple-neighborhood topology until all computing devices of the set of networked computing devices have received the respective transaction; and upon approval of the respective transaction by a respective vote from at least a majority of computing devices of the set of networked computing devices, recording the respective transaction on the distributed ledger; and a respective judicial module operating a respective judicial protocol on each respective computing device, wherein fault detection occurs via application of the respective judicial protocol in which a majority of computing devices in a respective neighborhood can take an action against a faulty computing device of the respective neighborhood by determining that the faulty computing device violates one or more rule of the set of rules.

Clause 2. The system of clause 1, wherein the action against the faulty computing device comprises removing the faulty computing device from participating in a consensus operation of the respective neighborhood of computing devices until a fault event is remedied.

Clause 3. The system of clause 1 or of any preceding claim, wherein the respective consensus algorithm operates in an asynchronous manner.

Clause 4. The system of clause 1 or of any preceding claim, wherein the respective judicial module operates on each respective computing device such that there is no centralized judicial process.

Clause 5. The system of clause 1 or of any preceding claim, wherein continuing to communicate the respective transaction from neighborhood to neighborhood in the set of networked computing devices according to the multiple-neighborhood topology until all devices of the set of networked computing devices have received the respective transaction further comprises each respective computing device that receives the respective transaction from a sending computing device will communicate the respective transaction to each other computing device in its respective assigned group of neighborhoods except to the sending computing device.

Clause 6. The system of clause 1 or of any preceding claim, wherein communicating the respective transaction to each neighbor of the first computing device is performed using a communication protocol that does not require an acknowledgement return signal to the first computing device.

Clause 7. The system of clause 1 or of any preceding claim, wherein the group of neighborhoods comprises two or more neighborhoods.

Clause 8. The system of clause 1 or of any preceding claim, wherein the transaction protocol drops duplicate transactions as they are identified.

Clause 9. The system of clause 1 or of any preceding claim, wherein the transaction protocol puts all transactions approved by the set of networked computing devices into a single line of transactions via a deterministic order.

Clause 10. The system of clause 9 or of any preceding claim, wherein the transaction protocol orders all ordering attributes are assigned in a place in the single line in a non-chronological order.

Clause 10. The system of clause 9 or of any preceding claim, wherein transaction protocol orders all ordering attributes are assigned in a place in the single line according to respective ordering attributes associated with each respective transaction.

Clause 11. The system of clause 9 or of any preceding claim, wherein the transaction protocol implements a delay period for ordering each respective transaction into the single line and packages a group of transactions into a preframe.

Clause 12. The system of clause 11 or of any preceding claim, wherein the transaction protocol on a respective computing device sends the preframe out to the respective neighborhood of computing devices for a vote to confirm that each computing device of the set of networked computing devices have a same ordered line of transactions as does the single line in the preframe to yield a first consensus.

Clause 13. The system of clause 12 or of any preceding claim, wherein the transaction protocol, based on the first consensus for the preframe, packages the preframe with other preframes that have also received consensus from the set of networked computing devices, to yield a group of preframes comprising a frame that is recorded on the distributed ledger.

Clause 14. The system of clause 13 or of any preceding claim, wherein the frame is assigned by the transaction protocol a unique transaction identifier for a set of transactions associated with the frame.

Clause 15. The system of clause 1 or of any preceding claim, wherein the respective transaction is received at the first computing device from an electronic wallet associated with a user device.

Clause 16. The system of clause 15 or of any preceding claim, wherein the respective transaction is associated with a transaction, which may or may not be a cryptocurrency transaction.

Clause 17. The system of clause 1 or of any preceding claim, wherein each respective computing device is equal to each other respective computing device and wherein all transactions require a consensus to be recorded on a ledger.

Clause 17. The system of clause 1 or of any preceding claim, wherein transactions recorded on the distributed ledger are immutable and the distributed ledger only persists in a forward direction.

Clause 18. The system of clause 1 or of any preceding claim, wherein each respective computing device of the set of networked computing devices receives a broadcast associated with each respective transaction according to the multiple-neighborhood topology.

Clause 19. The system of clause 1 or of any preceding claim, wherein each respective computing device is distributed across a public network, equal and independent.

Clause 20. The system of clause 1 or of any preceding claim, wherein the topology protocol followed by each respective computing device comprises (1) at least procedures and rules each respective computing device follows to actively participate in operating its respective consensus algorithm and (2) an ability to self-organize in network alignment to sustain an adequate overlay coverage across the set of networked computing devices according to the multiple-neighborhood topology.

Clause 21. The system of clause 1 or of any preceding claim, wherein the transaction protocol comprises procedures and rules each respective computing device must follow to actively participate in processing, voting and maintaining the respective ledger as part of the distributed ledger.

Clause 22. The system of clause 1 or of any preceding claim, wherein the respective judicial protocol comprises each respective computing device actively monitoring and correction controls overseeing all interactions of other computing devices within its respective neighborhoods and providing guardrails against malicious attack vectors, non-compliant messaging, or underperforming neighbor computing devices which may compromise an overall stability of the set of networked computing devices.

Clause 23. The system of clause 1 or of any preceding claim, wherein communicating the respective transaction to each neighbor of the first computing device is performed using a message delivery protocol that does not provide an acknowledgement return signal.

Clause 24. The system of clause 23 or of any preceding claim, wherein the message delivery protocol comprises a user datagram protocol (UDP).

Clause 25. A method of connecting a new respective computing device to a set of networked computing devices configured in a multiple-neighborhood topology, the method comprising: receiving a verified approved configuration of all computing devices in a group of neighborhoods that the new respective computing device is part of in the multiple-neighborhood topology; announcing, from the new respective computing device, a current state to the group of neighborhoods; if the current state indicates that there is missing activity with respect to a distributed ledger of which the new respective computing device has a respective local ledger as part of the distributed ledger, then working with the group of neighborhoods to request the missing activity to update the respective local ledger on the new respective computing device, wherein previously unknown transactions received during a synchronization process must successfully reach consensus to be accepted.

Clause 26. A method comprising: implementing a topology protocol operating on each respective computing device of a set of networked computing devices configured in a multiple-neighborhood topology, each respective computing device of the set of networked computing devices: (1) being configured as part of the multiple-neighborhood topology in which each respective computing device is assigned to a group of neighborhoods and (2) following a topology protocol to yield a respective assigned group of neighborhoods for the respective computing device, wherein each respective neighborhood of the group of neighborhoods comprises a different subset of the set of networked computing devices in which the different subset of the set of networked computing devices only communicates with other computing devices in its respective assigned group of neighborhoods; operating the set of networked computing device such that a new transaction received at each respective computing device is processed by the respective computing device by operations comprising: confirming a valid signature of the new transaction and generating a condition for the new transaction to generate a stamped transaction; transmitting the stamped transaction to the respective assigned group of neighborhoods for the respective computing device using an unacknowledging delivery protocol; ordering the stamped transaction with other new transactions according to respective conditions on the other new transactions to yield an ordered list of new transactions; waiting a time delay; generating a preframe based on the ordered list of new transactions; transmitting the ordered list of new transactions to the respective assigned group of neighborhoods for the respective computing device; receiving a respective proposed ordered list of new transactions from each of the respective assigned group of neighborhoods for the respective computing device; comparing the ordered list of new transactions to the respective proposed ordered list of newt transactions to yield a comparison; when the comparison achieves consensus amongst each neighborhood of the respective assigned group of neighborhoods for the respective computing device, submitting the ordered list of new transactions to a ledger container; and applying, via the ledger container, the list of new transactions to an immutable ledger operating on the respective computing device.

Clause 27. The method of clause 26, wherein the condition comprises a time stamp.

Clause 28. A method of managing a transaction lifecycle on a node of a blockchain network having a topology protocol operating on each respective node of a set of networked nodes configured in a multiple-neighborhood topology, each respective node of the set of networked nodes: (1) being configured as part of the multiple-neighborhood topology in which each respective node is assigned to a group of neighborhoods and (2) following a topology protocol to yield a respective assigned group of neighborhoods for the respective node, wherein each respective neighborhood of the group of neighborhoods comprises a different subset of the set of networked nodes in which the different subset of the set of network nodes only communicates with other nodes in its respective assigned group of neighborhoods, the method comprising: receiving a new transaction request from one of a wallet or another node; collecting all new transaction requests older than a time delay into a collection of new transaction requests; grouping the collection of new transaction requests in an order to generate a preframe; broadcasting the preframe to the group of neighborhoods assigned to the node; voting as part of a consensus algorithm with other nodes of the group of neighborhoods assigned to the node on a content and an order of the collection of new transaction requests in the preframe to yield a vote; when, based on the vote or other votes of the nodes of the group of neighborhoods assigned to the node, a consensus is reached, submitting the collection of transactions in the preframe to an immutable ledger.

Clause 29. A computing device operating a blockchain network having a topology protocol operating on each respective computing device of a set of networked computing device configured in a multiple-neighborhood topology, each respective computing device of the set of networked computing devices: (1) being configured as part of the multiple-neighborhood topology in which each respective computing device is assigned to a group of neighborhoods and (2) following a topology protocol to yield a respective assigned group of neighborhoods for the respective computing device, wherein each respective neighborhood of the group of neighborhoods comprises a different subset of the set of networked computing devices in which the different subset of the set of networked computing devices only communicates with other computing devices in its respective assigned group of neighborhoods, the computing device comprising: an incoming message queue configured to receive a new transaction, confirm the new transaction and apply a stamp to the new transaction to yield a stamped transaction; a judicial component that causes the new transaction to be discarded if the new transaction is at least one of improperly formed, does not have a valid signature, or does not have a valid fee; an incoming container that receives the stamped transaction and broadcasts the stamped transaction to the respective assigned group of neighborhoods for the computing device and generates an ordered set of new transactions comprising the stamped transaction and other stamped transactions; a preframe container that generates a preframe comprising the ordered set of new transactions and broadcasts the preframe to the respective assigned group of neighborhoods for the computing device; a voting container that receives the preframe from the preframe container, receives other preframes from the respective assigned group of neighborhoods for the computing device and votes on a content of the preframe and the other preframes and an order of transactions in the other preframes to yield a vote associated with a consensus; and a ledger container that when the preframe and other preframes meet the consensus among a majority of computing devices in the respective assigned group of neighborhoods for the computing device, adds the preframe to a ledger operating on the computing device.

Clause 30. The computing device of clause 29, wherein the stamp comprises a time stamp or a condition independent of time.

Clause 31. A system connecting a new respective computing device to a set of networked computing devices configured in a multiple-neighborhood topology, the system comprising: at least one processor; and a computer-readable storage medium storing instructions which, when executed by the at least one processor, cause the at least one processor to be configured to: receive a verified approved configuration of all computing devices in a group of neighborhoods that the new respective computing device is part of in the multiple-neighborhood topology; announce, from the new respective computing device, a current state to the group of neighborhoods; if the current state indicates that there is missing activity with respect to a distributed ledger of which the new respective computing device has a respective local ledger as part of the distributed ledger, then work with the group of neighborhoods to request the missing activity to update the respective local ledger on the new respective computing device, wherein previously unknown transactions received during a synchronization process must successfully reach consensus to be accepted.

Clause 32. A system comprising: at least one processor; and a computer-readable storage medium storing instructions which, when executed by the at least one processor, cause the at least one processor to be configured to: implement a topology protocol operating on each respective computing device of a set of networked computing devices configured in a multiple-neighborhood topology, each respective computing device of the set of networked computing devices: (1) being configured as part of the multiple-neighborhood topology in which each respective computing device is assigned to a group of neighborhoods and (2) following a topology protocol to yield a respective assigned group of neighborhoods for the respective computing device, wherein each respective neighborhood of the group of neighborhoods comprises a different subset of the set of networked computing devices in which the different subset of the set of networked computing devices only communicates with other computing devices in its respective assigned group of neighborhoods; operate the set of networked computing devices such that a new transaction received at each respective computing device is processed by the respective computing device by operations comprising: confirming a valid signature of the new transaction and generating a condition for the new transaction to generate a stamped transaction; transmitting the stamped transaction to the respective assigned group of neighborhoods for the respective computing device using an unacknowledging delivery protocol; ordering the stamped transaction with other new transactions according to respective conditions on the other new transactions to yield an ordered list of new transactions; waiting a time delay; generating a preframe based on the ordered list of new transactions; transmitting the ordered list of new transactions to the respective assigned group of neighborhoods for the respective computing device; receiving a respective proposed ordered list of new transactions from each of the respective assigned group of neighborhoods for the respective computing device; comparing the ordered list of new transactions to the respective proposed ordered list of new transactions to yield a comparison; when the comparison achieves consensus amongst each neighborhood of the respective assigned group of neighborhoods for the respective computing device, submitting the ordered list of new transactions to a ledger container; and applying, via the ledger container, the list of new transactions to an immutable ledger operating on the respective computing device.

Clause 33. The system of clause 32, wherein the condition comprises a time stamp.

Clause 34. A system that managing a transaction lifecycle on a node of a blockchain network having a topology protocol operating on each respective node of a set of networked nodes configured in a multiple-neighborhood topology, each respective node of the set of networked nodes: (1) being configured as part of the multiple-neighborhood topology in which each respective node is assigned to a group of neighborhoods and (2) following a topology protocol to yield a respective assigned group of neighborhoods for the respective node, wherein each respective neighborhood of the group of neighborhoods comprises a different subset of the set of networked nodes in which the different subset of the set of network nodes only communicates with other nodes in its respective assigned group of neighborhoods, the system comprising: at least one processor; and a computer-readable storage medium storing instructions which, when executed by the at least one processor, cause the at least one processor to be configured to: receive a new transaction request from one of a wallet or another node; collect all new transaction requests older than a time delay into a collection of new transaction requests; group the collection of new transaction requests in an order to generate a preframe; broadcast the preframe to the group of neighborhoods assigned to the node; vote as part of a consensus algorithm with other nodes of the group of neighborhoods assigned to the node on a content and an order of the collection of new transaction requests in the preframe to yield a vote; when, based on the vote or other votes of the nodes of the group of neighborhoods assigned to the node, a consensus is reached, submit the collection of transactions in the preframe to an immutable ledger.

Clause 35. A computer-readable storage medium storing instructions which, when executed by at least one processor, cause the at least one processor to be configured to perform the operations of any previous clause or to perform any operation disclosed herein.

Clause 36. A system comprising one or more means for performing any operation disclosed herein or in any previous clause.

We claim:

1. A system, comprising:
a set of networked computing devices configured in a multiple-neighborhood topology, each respective computing device of the set of networked computing devices being configured as part of the multiple-neighborhood topology in which each respective computing device is assigned to a group of neighborhoods and follows a topology protocol to yield a respective assigned group of neighborhoods for the respective computing device, wherein each respective neighborhood of the group of neighborhoods comprises a different subset of the set of networked computing devices in which the different subset of the set of networked computing devices only communicates with other computing devices in its respective assigned group of neighborhoods;
a respective ledger operating on each respective computing device for recording transactions, wherein a combination of each respective ledger on each respective computing device comprises a distributed ledger;
a respective consensus algorithm running on each respective computing device such that when a respective transaction of a group of transactions is to be made via application of the respective consensus algorithm, a set of rules according to a transaction protocol applies in order for the respective transaction to be recorded on the distributed ledger, wherein the transaction protocol comprises a combination each operation of each respective consensus algorithm on each respective computing device and further comprises:
receiving, at a first computing device in a first neighborhood, the respective transaction to be recorded on the distributed ledger across the set of networked computing devices;
communicating the respective transaction to each neighbor of the first computing device, wherein each neighbor of the first computing device comprises the respective assigned group of neighborhoods for the first computing device;
continuing to communicate the respective transaction from neighborhood to neighborhood in the set of networked computing devices according to the multiple-neighborhood topology until all computing devices of the set of networked computing devices have received the respective transaction; and
upon approval of the respective transaction by a respective vote from at least a majority of computing devices of the set of networked computing devices, recording the respective transaction on the distributed ledger; and
a respective judicial module operating a respective judicial protocol on each respective computing device, wherein fault detection occurs via application of the respective judicial protocol in which a majority of computing devices in a respective neighborhood can take an action against a faulty computing device of the respective neighborhood by determining that the faulty computing device violates one or more rule of the set of rules.

2. The system of claim 1, wherein the action against the faulty computing device comprises removing the faulty computing device from participating in a consensus operation of the respective neighborhood of computing devices until a fault event is remedied.

3. The system of claim 1, wherein the respective consensus algorithm operates in an asynchronous manner.

4. The system of claim 1, wherein the respective judicial module operates on each respective computing device such that there is no centralized judicial process.

5. The system of claim 1, wherein continuing to communicate the respective transaction from neighborhood to neighborhood in the set of networked computing devices according to the multiple-neighborhood topology until all devices of the set of networked computing devices have received the respective transaction further comprises each respective computing device that receives the respective transaction from a sending computing device will communicate the respective transaction to each other computing device in its respective assigned group of neighborhoods except to the sending computing device.

6. The system of claim 1, wherein communicating the respective transaction to each neighbor of the first computing device is performed using a communication protocol that does not require an acknowledgement return signal to the first computing device.

7. The system of claim 1, wherein the group of neighborhoods comprises two or more neighborhoods.

8. The system of claim 1, wherein the transaction protocol drops duplicate transactions as they are identified.

9. The system of claim 1, wherein the transaction protocol puts all transactions approved by the set of networked computing devices into a single line of transactions via a deterministic order.

10. The system of claim 9, wherein the transaction protocol orders all ordering attributes are assigned in a place in the single line in a non-chronological order or wherein transaction protocol orders all ordering attributes are assigned in a place in the single line according to respective ordering attributes associated with each respective transaction.

11. The system of claim 9, wherein the transaction protocol implements a delay period for ordering each respective transaction into the single line and packages a group of transactions into a preframe.

12. The system of claim 11, wherein the transaction protocol on a respective computing device sends the preframe out to the respective neighborhood of computing devices for a vote to confirm that each computing device of the set of networked computing devices have a same ordered line of transactions as does the single line in the preframe to yield a first consensus.

13. The system of claim 12, wherein the transaction protocol, based on the first consensus for the preframe, packages the preframe with other preframes that have also received consensus from the set of networked computing devices, to yield a group of preframes comprising a frame that is recorded on the distributed ledger.

14. The system of claim 13, wherein the frame is assigned by the transaction protocol a unique transaction identifier for a set of transactions associated with the frame.

15. The system of claim 1, wherein the respective transaction is received at the first computing device from an electronic wallet associated with a user device.

16. The system of claim 15, wherein the respective transaction is associated with a transaction.

17. The system of claim 1, wherein each respective computing device is equal to each other respective computing device and wherein all transactions require a consensus to be recorded on a ledger or wherein transactions recorded on the distributed ledger are immutable and the distributed ledger only persists in a forward direction.

18. The system of claim 1, wherein each respective computing device of the set of networked computing devices receives a broadcast associated with each respective transaction according to the multiple-neighborhood topology.

19. The system of claim 1, wherein each respective computing device is distributed across a public network, equal and independent.

20. The system of claim 1, wherein the topology protocol followed by each respective computing device comprises (1) at least procedures and rules each respective computing device follows to actively participate in operating its respective consensus algorithm and (2) an ability to self-organize in network alignment to sustain an adequate overlay coverage across the set of networked computing devices according to the multiple-neighborhood topology.

21. The system of claim 1, wherein the transaction protocol comprises procedures and rules each respective computing device must follow to actively participate in processing, voting and maintaining the respective ledger as part of the distributed ledger.

22. The system of claim 1, wherein a respective judicial protocol comprises each respective computing device actively monitoring and correction controls overseeing all interactions of other computing devices within its respective neighborhoods and providing guardrails against malicious attack vectors, non-compliant messaging, or underperforming neighbor computing devices which may compromise an overall stability of the set of networked computing devices.

23. The system of claim 1, wherein communicating the respective transaction to each neighbor of the first computing device is performed using a message delivery protocol that does not provide an acknowledgement return signal.

24. The system of claim 23, wherein the message delivery protocol comprises a user datagram protocol (UDP).

25. A method of connecting a new respective computing device to a set of networked computing devices configured in a multiple-neighborhood topology, the method comprising:
receiving a verified approved configuration of all computing devices in a group of neighborhoods that the new respective computing device is part of in the multiple-neighborhood topology;
announcing, from the new respective computing device, a current state to the group of neighborhoods;
if the current state indicates that there is missing activity with respect to a distributed ledger of which the new respective computing device has a respective local ledger as part of the distributed ledger, then working with the group of neighborhoods to request the missing activity to update the respective local ledger on the new respective computing device, wherein previously unknown transactions received during a synchronization process must successfully reach consensus to be accepted.

26. A method comprising:
implementing a topology protocol operating on each respective computing device of a set of networked computing devices configured in a multiple-neighborhood topology, each respective computing device of the set of networked computing devices: (1) being configured as part of the multiple-neighborhood topology in which each respective computing device is assigned to a group of neighborhoods and (2) following a topology protocol to yield a respective assigned group of neighborhoods for the respective computing device, wherein each respective neighborhood of the group of neighborhoods comprises a different subset of the set of networked computing devices in which the different subset of the set of networked computing devices only communicates with other computing devices in its respective assigned group of neighborhoods;
operating the set of networked computing devices such that a new transaction received at each respective computing device is processed by the respective computing device by operations comprising:
confirming a valid signature of the new transaction and generating a condition for the new transaction to generate a stamped transaction;
transmitting the stamped transaction to the respective assigned group of neighborhoods for the respective computing device using an unacknowledging delivery protocol;
ordering the stamped transaction with other new transactions according to respective conditions on the other new transactions to yield an ordered list of new transactions;
waiting a time delay;
generating a preframe based on the ordered list of new transactions;
transmitting the ordered list of new transactions to the respective assigned group of neighborhoods for the respective computing device;
receiving a respective proposed ordered list of new transactions from each of the respective assigned group of neighborhoods for the respective computing device;
comparing the ordered list of new transactions to the respective proposed ordered list of new transactions to yield a comparison;
when the comparison achieves consensus amongst each neighborhood of the respective assigned group of neighborhoods for the respective computing device, submitting the ordered list of new transactions to a ledger container; and
applying, via the ledger container, the list of new transactions to an immutable ledger operating on the respective computing device.

27. The method of claim 26, wherein the condition comprises a time stamp.
